(19) United States
(12) Patent Application Publication
(10) Pub. No.: US 2021/0264521 A1
(43) Pub. Date: Aug. 26, 2021

(54) GLOBAL ASSET ALLOCATION AND MANAGEMENT SERVICE PROVIDING SYSTEM

(71) Applicant: QUANTEC CO., LTD., Seoul (KR)

(72) Inventors: Sang Geun LEE, Seoul (KR); Yong Seok CHOI, Seoul (KR)

(21) Appl. No.: 17/256,641

(22) PCT Filed: Jun. 27, 2019
(86) PCT No.: PCT/KR2019/007818

§ 371 Date: Dec. 28, 2020

(30) Foreign Application Priority Data
Jun. 27, 2018 (KR) 10-2018-0073826
May 8, 2019 (KR) 10-2019-0053739
May 8, 2019 (KR) 10-2019-0053740

(51) Int. Cl. G06Q 40/06; G06Q 30/02

(52) U.S. Cl. CPC G06Q 40/06; G06Q 30/0201

(57) ABSTRACT

Provided is an asset allocation service providing method of a service providing device, the method including the steps of: acquiring user analysis information from user input information inputted to a user terminal; determining asset setting information corresponding to the user analysis information; applying the asset setting information to an asset allocation engine based on model information pre-stored to create initial portfolio information; providing the initial portfolio information to the user terminal and acquiring user customized information corresponding to the initial portfolio information from the user terminal; and providing real-time simulation information using a user customized asset allocation model determined based on the user customized information to the user terminal.

### TECHNICAL FIELD

The present invention relates to a service providing method and device. More particularly, the present invention relates to a global asset allocation and management service providing system.

### BACKGROUND ART

A customer who makes an agency contract for his or her financial assets with a financial company desires high income and also expects stability. Accordingly, the financial company collects and manages investment funds from a plurality of contractors, tries to keep the principal of the investment funds of the contractors, and further suggests various products capable of pursuing the income from the principal of the investment funds.

As a method for efficiently allocating such products, a portfolio selection theory is widely used. According to the portfolio selection theory as one of strategies for effective asset investment, if expected returns are the same as one another for asset investment, products with asset classes having low levels of risk can be combined, and if levels of risk are the same as one another, products with asset classes with high expected returns can be combined.

A portfolio is built by an individual investor, but generally, it is recommended that the portfolio is made under the professional advisement of a branch office staff. However, a lot of time for the professional advisement is needed and it is not easy to ensure the reliability of the professional advisement. Accordingly, recently, automated portfolio building tools like robo-advisors have been suggested.

However, the current automated portfolio building tools are optimized only in determining an initial portfolio model to be recommended for a customer, and accordingly, they are hard to change the portfolio model determined already.

That is, the current automated portfolio building tools like the robo-advisors analyze the propensity of the customer through a survey, evaluate the analyzed result, and automatically suggest an optimal portfolio model to the customer, but if the initial portfolio model is determined and interworks with the account information of the customer, only consistent asset allocation and periodical rebalancing for the selected portfolio model are performed, so that it is impossible for the customer or investor to have the authority to change the portfolio model in real time or intervene in the portfolio model.

In this case, if the customer requests the portfolio model itself to be changed, his or her intervention in the portfolio model, or a simulation of the portfolio model, the current automated portfolio building tools make the customer select a new portfolio model again through account information interworking releasing, rejoining, and reanalysis, so that they have structural limitations in that they cannot be processed in real time according to the customer's needs. That is, the current automated systems like the robo-advisors have suggested only a process in which it is impossible to perform changing to another portfolio model, to execute a simulation of the changed portfolio model, or to remodel the portfolio model after the portfolio model has been selected once.

Like this, current asset allocation solution systems provide only unidirectional process led by branch offices and professionals and further block the real-time changing and intervention of the individual user like the customer or investor after he or she has initially joined the systems.

Because of the unidirectionality of the portfolio model and the difficulties in changing the portfolio model, also, the number of management strategies based on the portfolio model is just 3 to 4 by sales company, and accordingly, all power of the sales is collected to a small number of high net worth individuals.

Due to such limitations in the product sales and the structure of the sales, robo-advisor-based portfolios capable of being freely individualized to a large number of minority users are also restricted in their distribution path.

That is, asset management product sales companies to which a portfolio product class is consigned to sell the product class prefer a small number of high net worth individuals in view of the cost and efficiency of the portfolio management for them to a large number of minority users, so that the characteristics and advantages of the robo-advisors and the portfolio simulation tools are not utilized at all.

### DISCLOSURE

### Technical Problem

Accordingly, the present invention has been made to solve the above-mentioned problems, and it is an object of the present invention to provide a global asset allocation service providing method and device that is capable of performing a customized model portfolio simulation according to changes in setting led by a user and executing real-time reapplication, thereby overcoming the unidirectionality and non-real-time of the existing systems as mentioned above and increasing the conveniences of a customer or investor as the user.

It is another object of the present invention to provide a service providing terminal and a method for operating the same that are capable of allowing a portfolio item-based investment product created through a portfolio simulation to be easily made with investable objects expressible with earning rates, such as various financial products, investment assets, P2P funds, cryptocurrency, and so on, by means of every user, providing an asset management service network and system for sharing and selling the investment product, and permitting many users to build optimal asset allocation portfolio models customized to them, thereby avoiding a limited and uniform sales way in which only a small number of high net worth individuals are preferred as sales objects.

It is yet another object of the present invention to provide a global asset allocation and management service providing system that is capable of performing a customized model portfolio simulation according to changes in setting led by a user and executing real-time reapplication, thereby overcoming the unidirectionality and non-real-time of the existing systems as mentioned above and increasing the conveniences of a customer or investor as the user.

### Technical Solution

To accomplish the above-mentioned objects, according to one aspect of the present invention, there is provided an asset allocation service providing method of a service providing device, including the steps of: acquiring user analysis information from user input information inputted to a user terminal; determining asset setting information corresponding to the user analysis information; applying the asset setting information to an asset allocation engine based on model information pre-stored to create initial portfolio information; providing the initial portfolio information to the user terminal and acquiring user customized information corresponding to the initial portfolio information from the user terminal; and providing real-time simulation information using a user customized asset allocation model determined based on the user customized information to the user terminal.

To accomplish the above-mentioned objects, according to another aspect of the present invention, there is provided an asset management service providing method of a service providing device, including the steps of: acquiring user analysis information according to user input information inputted to a user terminal; providing a portfolio item interface inclusive of one or more investment asset-related portfolio items selected according to the user analysis information from a portfolio item market built based on an online network; and providing an asset allocation engine service corresponding to the selected portfolio items according to the user input corresponding to the portfolio item interface.

To accomplish the above-mentioned objects, according to yet another aspect of the present invention, there is provided a terminal operating method for providing an asset management service, including the steps of: receiving user input information for acquiring user analysis information and transmitting the user input information to an asset management service providing device; receiving one or more investment asset-related portfolio items selected according to the user analysis information from a portfolio item market built based on an online network from the asset management service providing device to output the received portfolio items through a portfolio item interface; and requesting the asset management service providing device to provide an asset allocation engine service corresponding to the selected portfolio items according to the user input corresponding to the portfolio item interface.

On the other hand, the methods according to the present invention so as to solve the above-mentioned problems can be carried out in the form of a program for executing the methods on a computer or in the form of a recording medium where the program is recorded.

### Advantageous Effects

According to the present invention, the asset allocation and management service providing system is capable of allowing a portfolio item-based investment product created through a portfolio simulation to be easily made with investable objects expressible with earning rates, such as various financial products, investment assets, P2P funds, cryptocurrency, and so on, by means of every user and providing an asset management service network and system for sharing and selling the investment product.

Accordingly, many users can build the optimal asset allocation portfolio models customized to them, thereby avoiding a limited and uniform sales way in which only a small number of high net worth individuals are preferred as sales objects.

According to the present invention, further, the global asset allocation and management service providing system is capable of determining the user customized asset allocation model according to the user customized information, providing the real-time simulation information corresponding to the user customized asset allocation model to the user terminal, and executing the model portfolio simulation and real-time reapplication through the changes in setting led by the user according to the real-time simulation information, thereby overcoming the unidirectionality and non-real-time of the existing systems as mentioned above and increasing the conveniences of a customer or investor as the user.

### BRIEF DESCRIPTION OF DRAWINGS

FIG. 1 is a schematic concept view showing a global asset allocation and management service providing system according to the present invention.

FIG. 2 is a more specific block diagram showing the asset allocation engine service providing device according to the embodiment of the present invention.

FIG. 3 is a more specific block diagram showing the user terminal according to the embodiment of the present invention.

FIG. 4 is a more specific block diagram showing the asset management service providing device according to the present invention.

FIG. 5 is a flowchart showing an asset allocation engine service providing method according to the present invention.

FIG. 6 is a flowchart showing a portfolio reapplication process according to the present invention.

FIGS. 7 to 16 show asset allocation engine service interfaces outputted through a user terminal according to the embodiment of the present invention.

FIG. 17 is a flowchart showing an asset management service providing method according to the present invention.

FIGS. 18 to 24 show asset management service interfaces outputted from the user terminal through the asset management service providing method according to the present invention.

FIG. 25 is a flowchart showing a sharing market service operation of the asset management service providing device according to the present invention.

FIGS. 26 to 32 show asset management service interfaces provided to the user terminal through the sharing market service according to the present invention.

FIG. 33 is a flowchart showing a portfolio item creating process of the asset management service providing device according to the present invention.

FIGS. 34 to 40 show the asset management service interfaces outputted from the user terminal through the portfolio item creating process according to the present invention.

FIG. 41 is a flowchart showing a portfolio item-based league process according to the present invention.

### MODE FOR INVENTION

While this invention is illustrated and described in a preferred embodiment, the device may be produced in many different configurations, forms, and materials. There is depicted in the drawings, and will hereinafter be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

It should be understood that detailed explanations on the principle, view and embodiment of the present invention may include structural and functional equivalents thereof. Further, it should be appreciated that such equivalents may include currently known equivalents as well as equivalents to be developed in the future, that is, all of devices that are invented to perform the same functions, irrespective of structures thereof.

For example, it should be understood that a block diagram in the present invention shows a conceptual view of an exemplary circuit explaining the principle of the present invention. Similarly, all flowcharts, state transition diagrams, and pseudo codes substantially appear on a computer readable medium, and they indicate various processes performed by a computer or processor, irrespective of whether the computer or processor is obviously shown.

Functions of various elements indicated on drawings including functional blocks indicated as a processor or a similar concept thereto are provided by the use of dedicated hardware as well as hardware having capability of implementing appropriate software. If the functions are provided by the processor, they are supplied by a single dedicated processor, a single shared processor, or a plurality of individual processors, and some of them can be shared.

Objects, characteristics and advantages of the present invention will be more clearly understood from the detailed description as will be described below and the attached drawings, and it is to be appreciated that those skilled in the art can change or modify the embodiments without departing from the scope and spirit of the present invention. If it is determined that the detailed explanation on the well known technology related to the present invention makes the scope of the present invention not clear, the explanation will be avoided for the brevity of the description.

Hereinafter, embodiments of the present invention will be explained with reference to the attached drawings.

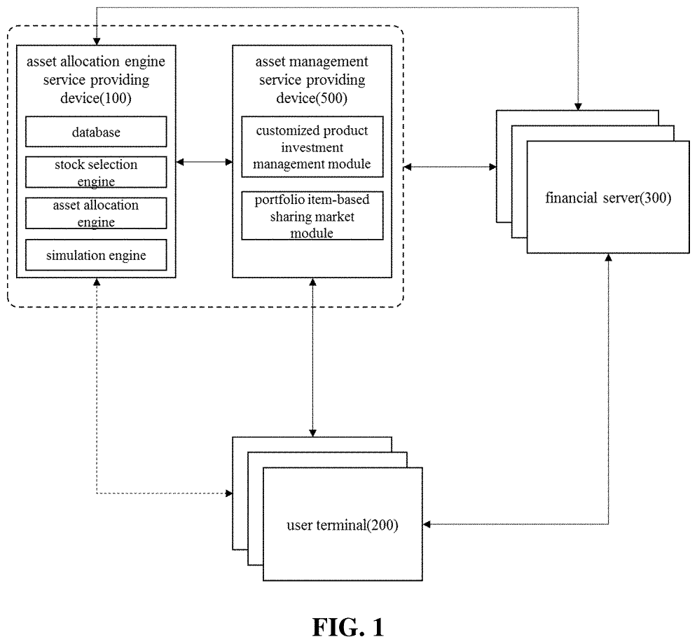

FIG. 1 is a schematic concept view showing a global asset allocation and management service providing system according to the present invention.

Referring to FIG. 1, a global asset allocation and management service providing system according to the present invention includes an asset allocation engine service providing device 100, an asset management service providing device 500, one or more user terminals 200, and one or more financial servers 300.

The respective components of the global asset allocation and management service providing system can be connected with one another through communication networks inclusive of wired/wireless internet networks. Further, networks for securely connecting their communication can be built among the asset allocation engine service providing device 100, the asset management service providing device 500, the user terminals 200, and the financial servers 300. In addition, the asset allocation engine service providing device 100, the user terminals 200, and the financial servers 300 include communication modules accessed to the communication networks to transmit and receive data.

For example, the communication networks are computer networks that can perform various data communication inclusive of a wired internet network with open internet and private intranet, a wireless internet communication network interworking with a mobile communication network, and data communication based on protocols such as Transmission Control Protocol (TCP)/Internet Protocol (IP), and User Datagram Protocol (UDP).

The asset allocation engine service providing device 100 interworks with the financial servers 300 according to a request of the user terminals 200 or the asset management service providing device 500 to thus handle one or more processes for providing an allot allocation engine service according to an embodiment of the present invention and provides the handled data to the asset management service providing device 500 or the user terminals 200.

In this case, the asset allocation engine service providing device 100 provides alloy allocation solution analysis and an alloy allocation processing service through the analysis to the asset management service providing device 500 or the user terminals 200 according to a request of the asset management service providing device 500 or the user terminals 200. To do this, the asset allocation engine service providing device 100 includes at least one of database, an stock selection engine, an asset allocation engine, and a simulation engine.

Through the stock selection engine, particularly, the asset allocation engine service providing device 100 according to an embodiment of the present invention can index financial data corresponding to a user's desired financial items for domestic and international listed companies and creates an stock selection portfolio with optimal investment stocks. In this case, the stock selection portfolio can be created with, for example, Quant algorithm.

Through driving of the asset allocation engine and the simulation engine according to the creation of the stock selection portfolio, further, the asset allocation engine service providing device 100 creates a customized model through the user's intervention and handles model simulations and real-time reapplication according to changed setting led by the user, in the asset allocation based on the portfolio applied at present to the user, thereby overcoming unidirectionality and non-real-time of the exiting robo-advisor.

In addition, the asset allocation engine service providing device 100 uploads the created customized allot allocation model to web sites so that related information is provided on online as well as offline, and all of customized asset allocation models include automated financial information processing processes capable of being algorithmificated to automatically process trading.

For example, portfolio items based on the customized asset allocation model created through the asset allocation engine service providing device 100 can be uploaded to a sharing market through the asset management service providing device 500.

The asset management service providing device 500 provides the portfolio items to other user terminals 200 through operation of the sharing market, so that other user terminals 200 check portfolio items of others, apply all or some of the portfolio items of others to their portfolio, and create new portfolio items again through combination with the portfolio items of others. In this case, all of customized asset allocation models included in the portfolio items include automated financial information processing processes capable of being algorithmificated to automatically process trading through the asset allocation engine service providing device 100. To do this, further, the asset management service providing device 500 includes a customized product investment management module for customized product investment management based on the asset allocation engine service providing device 100 according to user information registration of the user terminals 200 and a sharing market module based on portfolio items by user.

According to embodiments of the present invention, in this case, the portfolio items include asset allocation portfolio information that is shared in a market, sold, purchased, or combined, and earning rates by individual portfolio item are in real time operated and provided to the user terminals 200. That is, the portfolio items may be an investment product data set made by combining investable objects expressible with earning rates, such as various financial products, investment assets, P2P funds, cryptocurrency, and so on, according to user customized setting.

For example, the investment product data set corresponding to the portfolio items includes basic portfolio composition information, asset allocation information according to user customized setting, and combination information, combination ratio information and combination theme information if a plurality of portfolio items are combined with one another. Through driving of the asset allocation engine service providing device 100, also, past investment performance and simulation information corresponding to the investment product data set are provided in real time to the user terminals 200. The investment product data set can be registered on a sharing market network provided through the asset management service providing device 500 and can be shared to other users.

In this case, the sharing market network can be built by the user terminals 200 accessed to the asset management service providing device 500, and also, the sharing market network can be built based on a server network led by the asset management service providing device 500. Without being limited thereto, however, the sharing market network may be used with various forms of networks, such as internet networks, cloud networks, blockchain networks, and so on.

Accordingly, all of the users of the user terminals 200 can resister the investment product data set corresponding to the portfolio items on the asset management service providing device 500, receive portfolio simulations of the asset allocation engine service providing device 100, and share or sell the investment product data set to other users through the sharing market provided by the asset management service providing device 500.

As a result, the users can easily make portfolio item-based investment products through the user terminals 200, and the asset management service providing device 500 provides an asset management service network and system that shares and sells the portfolio item-based investment products. The asset allocation engine service providing device 100 executes stock selection, asset allocation, and simulation processes for creating the portfolio items and provides the results to the user terminals 200 or the asset management service providing device 500.

Further, the asset management service providing device 500 recommends for other users portfolio items proper to their propensity or standard through the user terminals 200, and among the recommended portfolio items, they select proper portfolio items to receive investment and automated trading service from the asset allocation engine service providing device 100, so that the users can have various portfolio item combinations and real-time setting changes to achieve changeable investments, irrespective of the amount of money.

Accordingly, many users make optimally customized asset allocation portfolio models to them, perform investments, and apply real-time changes, so that they are free from a limited and uniform sales way having only a small number of high net worth investors as objects.

To do this, the asset management service providing device 500 processes user registration through user account information checking and authentication implementation of each user terminal 200 and acquires user analysis information from user input information received from the user terminal 200 to provide the acquired user analysis information to the asset allocation engine service providing device 100.

On the other hand, the asset allocation engine service providing device 100 determines asset setting information corresponding to the user analysis information, applies the asset setting information to the asset allocation engine based on model information pre-stored to create initial portfolio information, provides the initial portfolio information to the asset management service providing device 500 or the user terminal 200, acquires user customized information corresponding to the initial portfolio information from the asset management service providing device 500 or the user terminal 200, and provides real-time simulation information using a user customized asset allocation model determined based on the user customized information to the asset management service providing device 500 or the user terminal 200, so that the asset allocation engine service providing device 100 creates the user customized asset allocation model and provides real-time simulation information on the user customized asset allocation model to the asset management service providing device 500 or the user terminal 200.

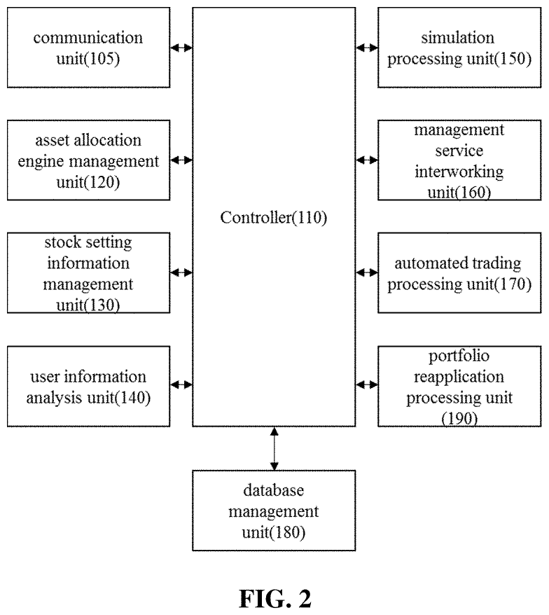

Accordingly, the asset allocation engine service providing device 100 includes the asset allocation engine for storing and managing one or more asset allocation models and the database for storing the user information, the asset setting information, the trading registration information, and the simulation information, and a specific configuration of the asset allocation engine service providing device 100 will be explained later with reference to FIG. 2.

Further, the asset allocation engine service providing device 100 communicates directly with the financial servers 300 or communicates with them through the asset management service providing device 500, thereby performing optimized financial processing of user investment assets according to automated trading service on the asset setting information.

On the other hand, the financial servers 300 are one or more financial institution servers, and for example, the financial servers 300 are bank servers or securities company servers that process asset transfer or trading information to investment object accounts according to a request of the asset allocation engine service providing device 100.

According to an embodiment of the present invention, especially, the asset allocation engine service providing device 100 processes the trading information with the financial servers 300 according to the simulation of the user customized asset allocation model and the application of the user customized asset allocation model, thereby providing the automated trading service based on the simulation.

The simulation and the automated trading service of the asset allocation engine service providing device 100 are executed through robo-advisors by product stock processed correspondingly to product stocks included in the user customized asset allocation model as the user customized asset allocation model is determined.

To do this, the asset allocation engine service providing device 100 combines the robo-advisors by stock according to the determination of the asset allocation model, and the combination is automatedly processed. According to the present invention, the asset allocation engine service providing device 100 functions as robo-advisors of the higher concept using the robo-advisors, which makes changed portfolio simulation and reapplication as will be discussed later easy.

On the other hand, the user terminal 200 may be a user's terminal that receives the user information, transmits and receives data to and from the asset management service providing device 500 and the asset allocation engine service providing device 100, and provides the asset management service based on the user information input and the communication with the asset management service providing device 500.

For example, the user terminal 200 is an electronic device, such as a smart phone, laptop computer, tablet PC, kiosk, and so on that can install service functions according to the present invention through applications.

According to an embodiment of the present invention, further, the user is a user to whom the asset management service is provided. For example, the user may be a direct investor as a user of the user terminal 200, and also, the user may be one of various users, such as a designer for designing an investment portfolio, an investment advisor, and so on, who receives the asset management service through the user terminal 200.

Also, the user terminal 200 processes the information provided from the asset management service providing device 500 and outputs the processed information through a display interface, and to do this, the user terminal 200 has one or more output units (not shown). The output units include interfaces for providing information to the user. For example, the output units include one or more display interfaces.

Further, the asset management service providing device 500 and the asset allocation engine service providing device 100 as separate devices have been explained in the embodiment of the present invention, but they are modularized and included as a component of one service providing device, without being limited thereto. According to the embodiment of the present invention, the whole or some functions of the asset management service providing device 500 and the asset allocation engine service providing device 100 are integratedly implemented in one service providing device or distributedly implemented by a plurality of service providing devices located on remote places.

FIG. 2 is a more specific block diagram showing the asset allocation engine service providing device according to the embodiment of the present invention.

Referring to FIG. 2, the asset allocation engine service providing device 100 according to the embodiment of the present invention includes a controller 110, a communication unit 105, an asset allocation engine management unit 120, an stock setting information management unit 130, a user information analysis unit 140, a simulation processing unit 150, a management service interworking unit 160, an automated trading processing unit 170, a portfolio reapplication processing unit 190, and a database management unit 180.

The communication unit 105 includes one or more communication modules that communicate with the asset management service providing device 500, the financial servers 300, or the user terminals 200 or that communicate with networks where the asset management service providing device 500, the financial servers 300, or the user terminals 200 are located.

In this case, the communication unit 105 is connected wirelessly or wiredly through a Local Area Network (LAN) and an internet network, through a Universal Serial Bus (USB) port, through a mobile communication network like 3G and 4G, and through near field wireless communication like Near Field Communication (NFC), Radio Frequency Identification (RFID), Wi-Fi, and so on.

Further, the communication unit 105 receives the user registration information for providing asset management and allocation services from the asset management service providing device 500 or each user terminal 200, and the user information analysis unit 140 registers user information according to the received user registration information and executes user management processing corresponding to the registered user information.

Especially, the user information analysis unit 140 provides a user analysis interface for user analysis to the user terminal 200 directly or through the asset management service providing device 500, analyses the user input information corresponding to the user analysis interface, and acquires user analysis information.

The stock setting information management unit 130 collects asset information from the asset management service providing device 500 or the user terminal 200, acquires stock setting information for the collected asset information, and stores and manages the acquired stock setting information. In this case, the stock setting information includes financial asset information to be invested by the user and asset class allocation information according to user selection, which are acquired from the user analysis information.

Further, the asset allocation engine management unit 120 applies the user analysis information and the stock setting information to the asset allocation engine with the asset allocation model information pre-set and determines the initial portfolio.

For example, the asset allocation engine management unit 120 applies the user analysis information and the stock setting information to a portfolio determination algorithm with the asset allocation model information set in advance, drives the asset allocation engine, and outputs asset allocation model information inclusive of the initial portfolio. To do this, the asset allocation engine management unit 120 stores and manages one or more asset allocation model engine information driven based on the user analysis information.

Further, the asset allocation model information inclusive of the initial portfolio is provided to the asset management service providing device 500 or the user terminal 200. In this case, the initial portfolio information includes a portfolio determined by the asset allocation model determined according to the user analysis information among one or more standard asset allocation models known already, according to the operation of the asset allocation engine management unit 120.

For example, the asset allocation model of the initial portfolio information is determined according to asset investment propensity through the user analysis and includes asset allocation ratios by asset type according to the asset investment propensity. For example, types of assets include ETF by stock, deposit/circulation funds, domestic bonds, domestic stocks, foreign stocks, foreign bonds, alternative investment funds, structured bonds, and Bancassurance. Accordingly, the initial portfolio information includes investment ratio information corresponding to the stocks by asset type, and the asset allocation model information corresponding to the investment ratio information is visualized to the form of a house view and is thus provided to the asset management service providing device 500 or the user terminal 200.

Accordingly, the initial portfolio information is outputted from the user terminal 200 through the portfolio interface. Further, the user terminal 200 receives the user customized information from the user and transmits the inputted customized information to the asset allocation engine service providing device 100. For example, the initial portfolio information has a standardized optimal investment ratio, but the user can request customized stock setting. According to the embodiment of the present invention, the user terminal 200 receives the user customized information for adding or changing the customized assets by stock, and the user customized information is transmitted to the asset allocation engine service providing device 100.

Further, the asset allocation engine management unit 120 changes the initial portfolio models into a user customized asset allocation model according to the user customized information and transmits the changed user customized asset allocation model information to the simulation processing unit 150.

The simulation processing unit 150 first processes a model simulation based on the initial portfolio information and provides the processed result information to the user terminal 200. In this case, financial information simulated according to the initial portfolio information includes the simulation results based on past financial information and is indicated with expected annual average return, annual volatility, maximum drawdown, Sharpe ratios, and so on.

If the user customized asset allocation model is determined, further, the simulation processing unit 150 performs a real-time simulation for the user customized asset allocation model and provides the simulation result to the user terminal 200. In this case, the user terminal 200 compares the simulation result of the initial portfolio model with the simulation result of the user customized asset allocation model, thereby making performance evaluation of the user very easy.

On the other hand, the user terminal 200 requests user trading registration corresponding to portfolio items acquired from the sharing market through the asset management service providing device 500 or the user customized asset allocation model registered directly in the user terminal 200, and according to the request of the user trading registration, the automated trading processing unit 170 receives user trading registration information inclusive of the user account information and the initial asset information and executes the automated trading process based on the user customized asset allocation model.

Accordingly, the automated trading processing unit 170 provides current asset allocation portfolio monitoring information according to the automated trading process to the user terminal 200. The monitoring information is provided in such a manner as to provide the current asset allocation portfolio model information through the portfolio interface of the user terminal 200.

On the other hand, the portfolio reapplication processing unit 190 receives changed setting information corresponding to the current asset allocation portfolio model information from the user terminal 200.

To do this, the user terminal 200 receives changed setting information through the portfolio interface, and the asset allocation engine management unit 120 creates a changed portfolio model based on the changed setting information. The simulation processing unit 150 processes the simulation based on the changed portfolio model and provides real-time simulation result comparison information between the current asset allocation portfolio model and the changed portfolio model to the user terminal 200. Accordingly, the user terminal 200 checks the comparison information and inputs a real-time portfolio model changing request.

The portfolio reapplication processing unit 190 executes reapplication of the changed portfolio model corresponding to the current account and asset of the user trading registration information, according to the real-time portfolio model changing request.

In this case, the portfolio reapplication processing unit 190 acquires current account information and current asset information corresponding to the user trading registration information pre-registered in advance, without addition or change in the user trading registration information, and executes automatic changing of the user trading registration information so as to reapply the current account information and the current asset information to the changed portfolio model from the current portfolio model.

Accordingly, the automated trading processing unit 170 executes an automated trading process according to the automatically changed user trading registration information and the changed portfolio model.

If the user customized asset allocation models by user are created, on the other hand, the management service interworking unit 160 uploads the user customized asset allocation model to a portfolio item sharing market through the asset management service providing device 500 under the request of the user terminal 200, so that the user customized asset allocation model can be used in product sales. To do this, the management service interworking unit 160 creates the user customized asset allocation model as portfolio items matched with the user information and registers the created portfolio items into the asset management service providing device 500, and the registered user customized asset allocation model is provided to a portfolio item data set capable of being shared with the second user terminal.

For example, the management service interworking unit 160 provides one or more recommended user customized asset allocation models to the asset management service providing device 500 according to the user analysis information of the second user terminal registered through the asset management service providing device 500 and shares one or more recommended user customized asset allocation models with the second user terminal accessed to the asset management service providing device 500, thereby allowing other users to easily execute the asset allocation model setting and changing using the user customized asset allocation model information.

Further, the management service interworking unit 160 acquires the portfolio item information from the asset management service providing device 500 according to an application request of the user terminal 200 and executes the asset allocation engine service corresponding to the acquired portfolio item information. In this case, the portfolio item information includes the user customized asset allocation model for driving the asset allocation engine service or the initial portfolio information and customized setting information for creating the user customized asset allocation model.

Accordingly, the management service interworking unit 160 executes the asset allocation engine service according to the portfolio item information and provides asset allocation engine service information to the asset management service providing device 500 or the user terminal 200.

In this case, the asset allocation engine service includes a management service for controlling operations of at least one of the respective modules (the asset allocation engine management unit 120, the stock setting information management unit 130, the user information analysis unit 140, the simulation processing unit 150, the automated trading processing unit 170, and the portfolio reapplication processing unit 190) controlled by the controller 110 to provide the result information to the asset management service providing device 500 or the user terminal 200.

Accordingly, the management service interworking unit 160 executes at least one of the asset allocation engine management, the stock setting, the user information analysis, the simulation processing, the automated trading processing, and the portfolio reapplication processing, which are based on the portfolio items acquired from the asset management service providing device 500 to provide the result information to the asset management service providing device 500 or the user terminal 200.

Further, as mentioned above, the controller 110 controls general operations of the respective units, and to do this, the controller 110 includes one or more microprocessors.

In addition, the database management unit 180 stores and manages the model information for the asset allocation engine application, the stock setting information by user, the user analysis information, the simulation processing information, the management service interworking information with the asset management service providing device 500, the automated trading processing information, and the portfolio reapplication processing information, and to do this, the database management unit 180 includes one or more storage media.

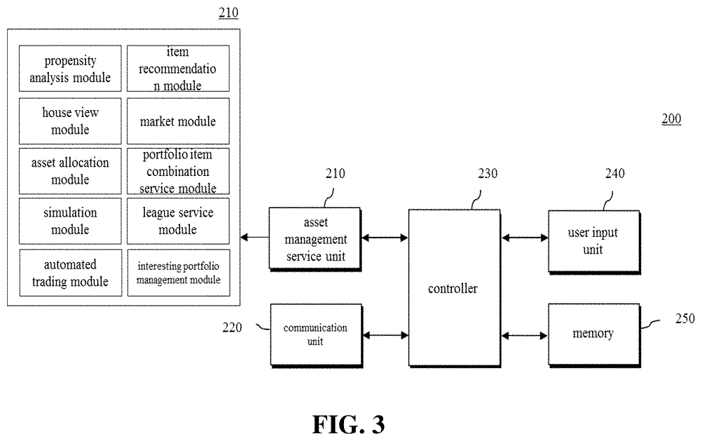

FIG. 3 is a more specific block diagram showing the user terminal according to the embodiment of the present invention.

Referring to FIG. 3, the user terminal 200 according to the present invention includes an asset management service unit 210, a communication unit 220, a controller 230, a user input unit 240, and a memory 250.

The communication unit 220 includes one or more modules capable of communicating with the networks at the user terminal 200, the asset allocation engine service providing device 100, and the asset management service providing device 500 are located or with the networks at the asset allocation engine service providing device 100 and the asset management service providing device 500 are located. For example, the communication unit 220 includes mobile communication modules, wireless internet modules, near field communication modules, or wired communication modules.

The user input unit 240 includes one or more interface modules for receiving user input. More specifically, the user input unit 240 receives various information, such as user input information for user analysis, user customized information for creating the user customized asset allocation model, model changing request information, automated trading registration information, and so on from the asset management service providing device 500 or the asset allocation engine service providing device 100 and processes the received information.

The controller 230 controls general operations of the user terminal 200, particularly, various asset allocation service operations through the asset management service unit 210.

The asset management service unit 210 provides various asset allocation services through communication with the asset allocation engine service providing device 100, under the control of the controller 230.

To provide the asset allocation engine service, accordingly, the asset management service unit 210 includes a propensity analysis module for outputting the user analysis information according to the user input information, a house view module for outputting the asset setting information in the form of the house view, an asset allocation module for outputting the user customized asset allocation model information, a simulation module for outputting the real-time simulation information, and an automated trading module for outputting the current asset allocation portfolio monitoring information according to the automated trading process if the asset allocation engine service providing device 100 receives the user trading registration information inclusive of the user account information and the initial asset information to execute the automated trading process based on the user customized asset allocation model.

So as to provide the asset management service based on portfolio items, further, the asset management service unit 210 includes an item recommendation module for recommending optimized portfolio items to the user, a market module for retrieving, applying or selecting the portfolio items shared in a market, a portfolio item combination service module for providing new portfolio items through combination of the portfolio items, a league service module for providing a competitive league service based on the sharing market of the personalized portfolio items, and an interesting portfolio management module for providing management and notification services for the portfolio items designated as interesting portfolios.

Accordingly, the user terminal 200 receives the asset management service processed in the asset management service unit 210 or provided from the asset management service providing device 500 and the asset allocation service provided from the asset allocation engine service providing device 100 and outputs the service information processed to a screen interface, video interface, or voice interface through an output unit under the control of the controller 230.

Further, the memory 250 includes one or more storage media for storing information inputted and outputted for a process for the control of the controller 230 and for the operations of the respective units.

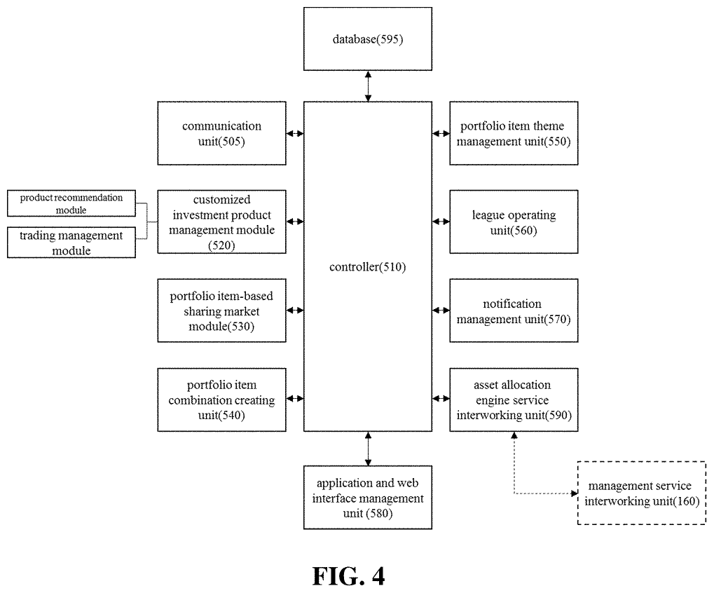

FIG. 4 is a more specific block diagram showing the asset management service providing device according to the present invention.

Referring to FIG. 4, the asset management service providing device 500 according to the present invention includes a controller 510, a communication unit 505, a customized investment product management module 520, a portfolio item-based sharing market module 530, a portfolio item combination creating unit 540, a portfolio item theme management unit 550, a league operating unit 560, an notification management unit 570, an asset allocation engine service interworking unit 590, and an application and web interface management unit 580.

First, the communication unit 505 includes one or more communication modules for communicating with the asset allocation engine service providing device 100, the financial servers 300, or the user terminals 200, or with the networks at which the asset allocation engine service providing device 100, the financial servers 300, or the user terminals 200 are located.

In this case, the communication unit 505 is connected wirelessly or wiredly through a Local Area Network (LAN) and an internet network, through a Universal Serial Bus (USB) port, through a mobile communication network like 3G and 4G, and through near field wireless communication like Near Field Communication (NFC), Radio Frequency Identification (RFID), Wi-Fi, and so on.

Further, the communication unit 505 receives the user registration information for providing asset management and allocation services from each user terminal 200.

The customized investment product management module 520 provides the user analysis service to the user terminal 200 whose user is registered, provides customized investment product information corresponding to the user analysis information, and provides a trading management service with the financial server 300 corresponding to the investment product determined according to the user selection. To do this, the customized investment product management module 520 includes a product recommendation module and a trading management module.

Further, the customized investment product management module 520 according to the present invention acquires the portfolio item (hereinafter referred to as port item) information from the sharing market built in advance in online network through the portfolio item-based sharing market module 530 and provides the product recommendation and trading management services based on the acquired portfolio item information.

The portfolio item-based sharing market module 530 builds a portfolio item-based sharing market through server computing, internet, block chain, cloud computing, or various online networks, creates and trades the portfolio items through the built market, and provides a market interface for creating and trading the portfolio items to the user terminal 200.

As mentioned above, in this case, the portfolio items (port items) include investment asset-related portfolio model information for providing or driving the asset allocation engine service, and they are matched with the user identification information id corresponding to a creator and are registered in advance in the sharing market.

The portfolio item-based sharing market module 530 provides to the user terminal 200 a portfolio item interface inclusive of one or more investment asset-related portfolio items selected correspondingly to the user analysis information analyzed in advance in the customized investment product management module 520 from the portfolio item market built on the online network.

Accordingly, the user terminal 200 receives various port item information through the portfolio item interface, and the user selects and inputs the port items proper to him or her.

Further, the customized investment product management module 520 processes the user trading information registration for the selected portfolio items and provides the port item information to the asset allocation engine service interworking unit 590, thereby providing the asset allocation engine service corresponding to the selected portfolio items.

The portfolio items are for example classified into two items. One of them is investment product data set of the customized portfolio model created through the asset allocation engine service providing device 100 and the other is the combined portfolio items.

First, the portfolio items inclusive of the customized portfolio model include the user customized asset allocation model created based on the initial portfolio model and the user analysis information through the asset allocation engine service providing device 100 and portfolio item creator information which shares the portfolio items in the market. The portfolio item information is used when it is desired that the user directly using the asset allocation engine service providing device 100 shares or sells the user customized asset allocation model through the market.

On the other hand, the combined portfolio items are created through the portfolio item combination creating unit 540 according to the input of the user terminal 200 and include combined portfolio items created by the combination of the plurality of portfolio items registered in advance in the market. The combined portfolio items include pieces of portfolio item identification information and ratio setting information corresponding to the pieces of portfolio item identification information.

The portfolio item combination creating unit 540 provides to the user terminal 200 a combination interface capable of combining personalized portfolio items to create combined portfolio items, creates combined portfolio items according to the user input corresponding to the combination interface, and requests the registration to the portfolio item-based sharing market module 530. Only through simple selection and ratio setting in the user terminal 200, accordingly, new portfolio items can be created and registered on the market.

More specifically, the portfolio item combination interface includes a portfolio item combination control interface selectable according to user input from the plurality of portfolio items registered on the market.

Further, the portfolio item combination creating unit 540 requests an asset allocation engine simulation through the asset allocation engine service interworking unit 590 according to automatic ratio setting information, receives the result information from the asset allocation engine service providing device 100, and thus automatically and optimally sets investment ratios among the items corresponding to the portfolio items selected through the portfolio item combination interface.

On the other hand, the portfolio item combination creating unit 540 can individually set the investment ratios among the items corresponding to the portfolio items selected through the portfolio item combination interface, according to the user input of manual ratio setting information.

Also, the portfolio item combination creating unit 540 requests the asset allocation engine simulation of the combined portfolio items created through the portfolio item combination interface to the asset allocation engine service interworking unit 590, receives earning rate information according to the request results, and provides the earning rate information to the user terminal 200.

Accordingly, the portfolio item combination creating unit 540 matches the combined portfolio items created through the portfolio item combination interface with the user information and transmits the results to the portfolio item-based sharing market module 530, and the portfolio item-based sharing market module 530 registers the combined portfolio items on the market to allow them to be shared or sold to other users.

The portfolio item-based sharing market module 530 receives an application selection request of another user for the registered portfolio items and determines whether the user can purchase the portfolio items through comparison with purchase conditions pre-set. For example, the purchase conditions include various conditions, such as user retention over assets set, maximum or minimum operating asset of the portfolio items, operating time, membership, usage fee payment, and so on.

If the portfolio items are purchasable, further, the portfolio item-based sharing market module 530 provides the automated trading service of the product asset based on the portfolio items through the asset allocation engine service interworking unit 590, and if earning occurs on the product asset invested according to the automated trading, provides a reward service to the portfolio item creator according to portfolio item earning setting information. In this case, the earning setting information is set according to various conditions, such as earning conditional reward ratio information, portfolio item application duration conditional reward information, and so on.

In providing the portfolio item interface, on the other hand, the portfolio item-based sharing market module 530 designates one or more portfolio items as interesting portfolio items according to user input. For example, the user terminal 200 transmits a bookmark item registration request or follow item registration request of the portfolio items to the asset management service providing device 500, and accordingly, the portfolio item-based sharing market module 530 designates the requested portfolio items as the interesting portfolio items to complete the processing for the bookmark item registration request or follow item registration request.

Accordingly, the notification management unit 570 provides a notification service for the portfolio items registered as the interesting portfolio items. The notification service includes a conditional notification message service for the interesting portfolio items. More specifically, the notification service includes a process for registering notification setting information based on the earning rates corresponding to the interesting portfolio items to provide a notification message to the user terminal according to the notification setting information.

Further, the notification setting information includes at least one of rising notification setting information in which the notification message is transmitted if the earning rates of the interesting portfolio items rise over earning rates set in advance and falling notification setting information in which the notification message is transmitted if the earning rates of the interesting portfolio items fall under the earning rates set in advance, which will be more specifically explained later.

On the other hand, the portfolio item theme management unit 550 sorts and stores the portfolio items of the sharing market according to the theme information included in the attribute information of the portfolio items, provides the sorted portfolio item list by theme to the portfolio item-based sharing market module 530, and allows the portfolio item list by theme to be provided to the user terminal 200 through the market interface. In this case, the theme information is inserted directly when the portfolio items are created in the user terminal 200, and otherwise, the theme information is created and inserted individually according to the portfolio item analysis of the portfolio item theme management unit 550.

On the other hand, the league operating unit 560 provides a ranking service among the portfolio items of the users whose league registration is requested according to the earning rates or earning information during league duration set in advance. Accordingly, participation of many users in creating the portfolio items can be enhanced.

Further, as mentioned above, the asset allocation engine service interworking unit 590 requests the management service interworking unit 160 of the asset allocation engine service providing device 100 to execute the whole or some of the asset allocation engine service functions according to the request of the portfolio item combination creating unit 540, the portfolio item-based sharing market module 530, or the customized investment product management module 520, and receives and processes the result.

More specifically, the asset allocation engine service interworking unit 590 acquires the asset setting information and the user customized information corresponding to the portfolio items selected in the portfolio item-based sharing market module 530 or the customized investment product management module 520 and transmits the acquired information to the asset allocation engine service providing device 100, and the asset allocation engine service providing device 100 applies the asset setting information to the asset allocation engine based on the model information stored in advance to create the initial portfolio information and provides the automated trading and monitoring service using the user customized asset allocation model determined according to the initial portfolio information and the user customized information to the user terminal 200.

Further, the asset allocation engine service interworking unit 590 requests the asset allocation engine service providing device 100 to allow the current asset allocation portfolio model information to be provided through the portfolio interface of the user terminal 200, and if the asset allocation engine service interworking unit 590 receives the changed setting information corresponding to the current asset allocation portfolio model information from the user terminal 200, provides the received changed setting information to the asset allocation engine service providing device 100. The asset allocation engine service providing device 100 creates the changed portfolio model based on the changed setting information, performs the simulation based on the changed portfolio model, and provides real-time simulation result comparison information between the current asset allocation portfolio model and the changed portfolio model to the user terminal 200.

Furthermore, the asset allocation engine service interworking unit 590 receives the real-time portfolio model changing request from the user terminal 200 and transmits the received request to the asset allocation engine service providing device 100, and the asset allocation engine service providing device 100 executes reapplication of the changed portfolio model corresponding to the current account and asset of the user trading registration information in response to the real-time portfolio model changing request.

The application and web interface management unit 580 creates applications or web API interfaces for performing the operations and functions of the asset management service providing device 500 and the asset allocation engine service providing device 100 according to the present invention, transmits them to the user terminal 200, and stores, updates, and manages related programs.

Further, as mentioned above, the controller 510 controls general operations of the respective units, and to do this, the controller 110 includes one or more microprocessors.

The database 595 stores and manages the user analysis information, the customized investment product information, the product recommendation information, the trading management information, the portfolio item-based sharing market information, the combination creating information, the theme management information, the league operating information, the notification management information, the asset allocation engine service interworking information, the application information, and the web interface information, and to do this, the database 595 includes one or more storage media.

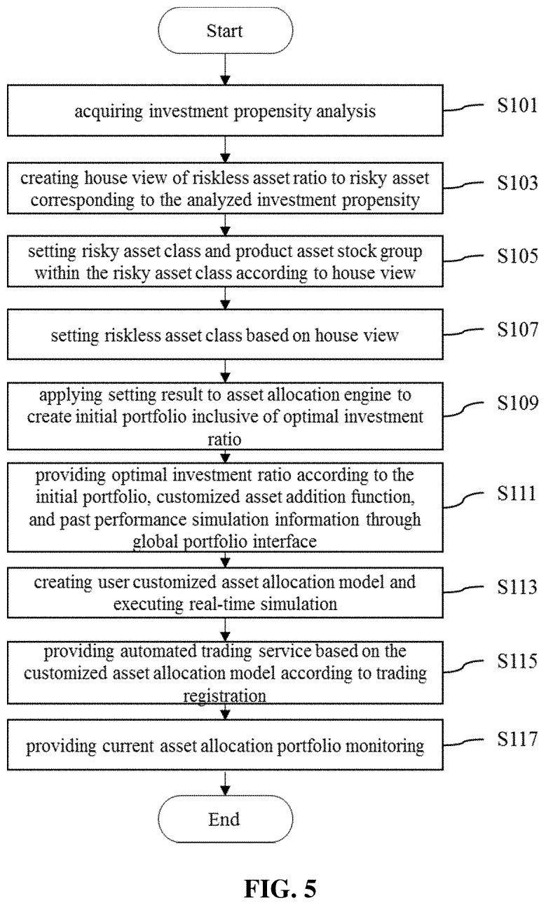

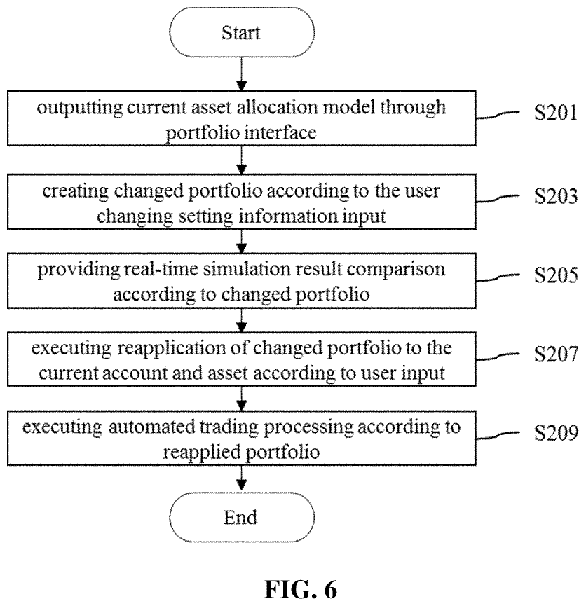

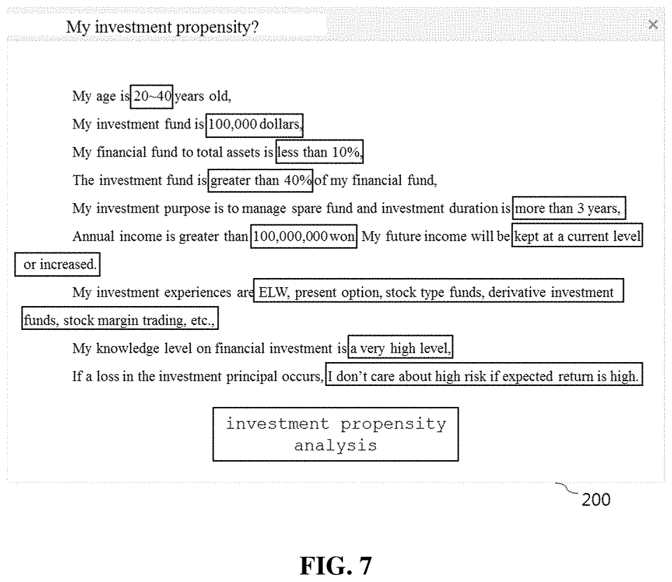

FIGS. 5 and 6 are flowcharts showing operating methods of the asset allocation engine service providing device according to the present invention, and FIGS. 7 to 16 show the service interfaces outputted through the user terminal according to an embodiment of the present invention in which the asset allocation engine service is provided.

Hereinafter, an explanation on an asset allocation engine service providing method according to the embodiment of the present invention will be in detail given with reference to FIGS. 5 to 16.

Referring first to FIG. 5, the user information analysis unit 140 of the asset allocation engine service providing device 100 provides an investment propensity analysis interface to the user terminal 200 (at step S101).

For example, as shown in FIG. 7, the investment propensity analysis interface includes a user interface for inputting at least one of user age information, asset information, financial asset information compared to total assets, investment purpose information, investment duration information, annual income information, future income information, investment experience information, investment knowledge level information, and loss handling information, and the information may be inputted in advance through the user terminal 200.

Further, for example, the investment propensity analysis interface can be provided to allow a propensity score to be calculated according to the user's question and answer information input, and the user information analysis unit 140 analyzes the user's investment propensity information according to the propensity score.

For example, the user information analysis unit 140 according to the present invention determines the propensity of an investor as any one of an aggressive investing type investor, an active investing type investor, a risk-neutral type investor, a safe-seeking type investor, and a safe investment type investor according to the propensity score.

Also, the asset allocation engine service providing device 100 creates a house view of a riskless asset ratio to a risky asset corresponding to the analyzed investment propensity and provides the created house view to the user terminal 200 (at step S103), and the stock setting information management unit 130 sets a risky asset class and a product asset stock class within the risky asset class according to the provided house view (at step S105) and further sets a riskless asset stock class according to the provided house view (at step S107).

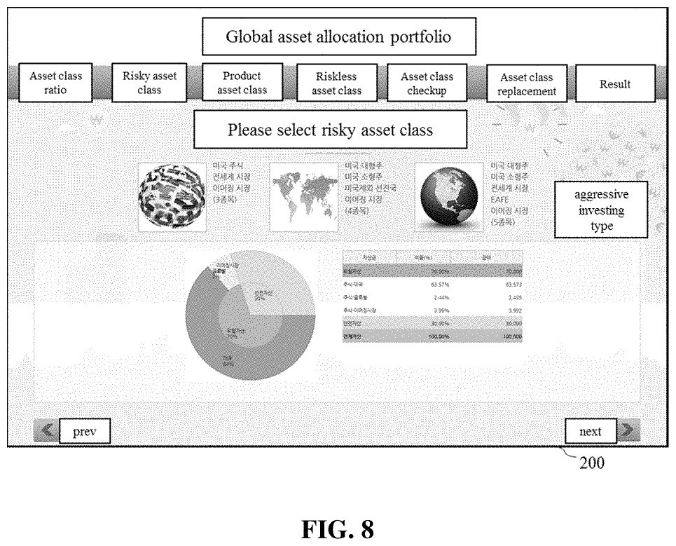

FIGS. 8 to 11 show stock setting interfaces for receiving stock setting information on the risky asset class and the riskless asset class, and the asset allocation engine service providing device 100 according to the present invention provides an stock setting house view corresponding to the user investment propensity analyzed, while processing the information set through the user.

To do this, the stock setting information management unit 130 determines the riskless asset ratio to the risky asset according to ratio information of any one of the aggressive investing type investor, the active investing type investor, the risk-neutral type investor, the safe-seeking type investor, and the safe investment type investor under the user's setting. For example, the riskless asset ratio to the risky asset for the safe investment type investor is 3:7, that for the safe-seeking type investor is 4:6, that for the risk-neutral type investor is 5:5, that for the active investing type investor is 6:4, and that for the aggressive investing type investor is 7:3.

Further, the stock setting information management unit 130 receives the risky asset class setting information as shown in FIG. 8 through the user terminal 200. For example, the user terminal 200 provides a selectable interface with groups bound up to the form of a house view provided by a stock company, and the stock group selected by the user input is reflected onto the risky asset class ratio.

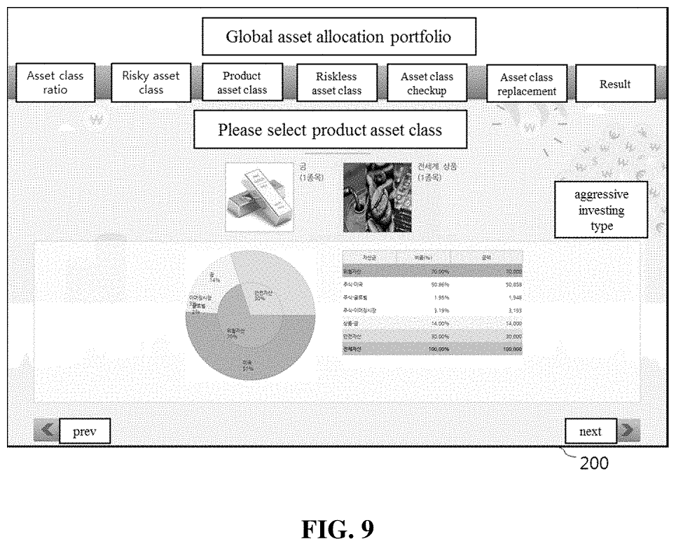

Further, the stock setting information management unit 130 receives the product asset class setting information in the risky asset class as shown in FIG. 9 through the user terminal 200. For example, the user terminal 200 provides a selectable interface with groups bound up to the form of a house view provided by a stock company, and the stock group selected by the user input is reflected onto the product asset class ratio in the risky asset.

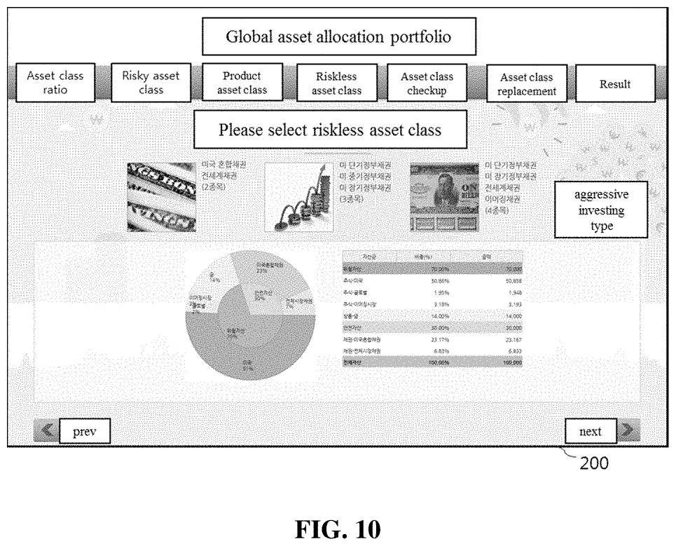

Also, the stock setting information management unit 130 receives riskless asset group setting information as shown in FIG. 10 through the user terminal 200. For example, the user terminal 200 provides a selectable interface with groups bound up to the form of a house view provided by a stock company, and the stock group selected by the user input is reflected onto the riskless asset class ratio.

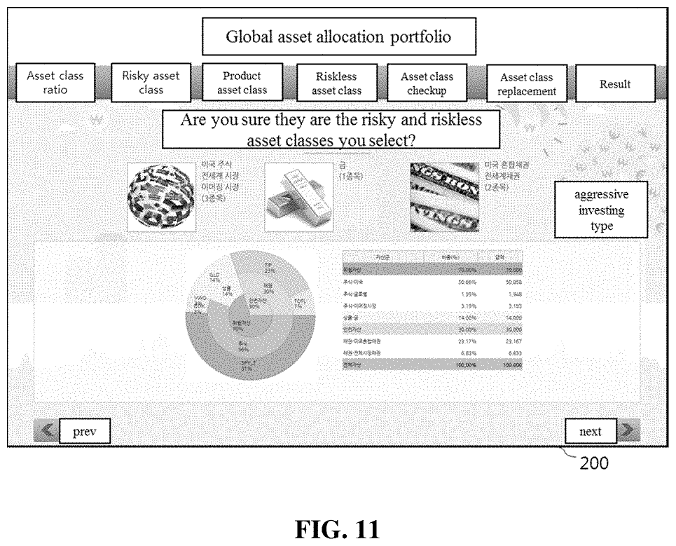

Accordingly, the stock setting information management unit 130 provides a setting checking interface as shown in FIG. 11, and the stock setting information selected by the user is provided to the asset allocation engine management unit 120 and the simulation processing unit 150.

After that, the asset allocation engine management unit 120 applies the setting result information to the asset allocation engine model to create the initial portfolio inclusive of the optimal investment ratio (at step S109).

Accordingly, the created initial portfolio is provided through the global portfolio interface of the user terminal 200. The asset allocation engine service providing device 100 provides the optimal investment ratio according to the initial portfolio, the customized asset addition function, and past performance simulation information through the global portfolio interface (at step S111).

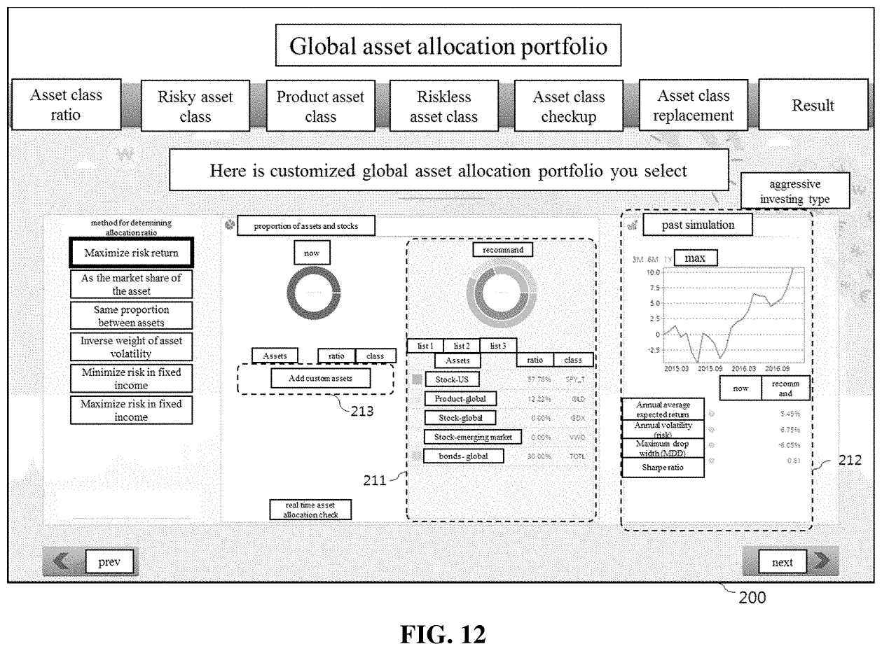

For example, as shown in FIG. 12, the user terminal 200 according to the present invention provides the initial portfolio information received from the asset allocation engine service providing device 100 through the portfolio interface.

In the portfolio interface provided by the user terminal 200, in particular, asset allocation ratio determination method selection information, the asset and stock ratio information, and the past performance simulation information are included, and the portfolio interface includes an optimal investment ratio interface 211 corresponding to the portfolio and a customized asset addition interface 213.

The optimal investment ratio interface 211 indicates allocation information corresponding to the initial portfolio or the user customized asset allocation model portfolio, and according to the user input to the customized asset addition interface 213, the user customized stock setting information corresponding to the initial portfolio is transmitted to the asset allocation engine service providing device 100.

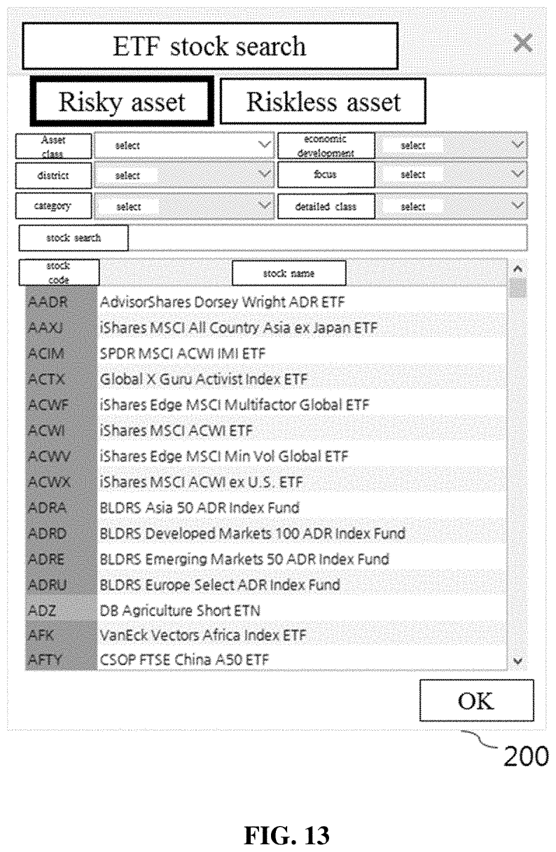

For example, as shown in FIG. 13, an stock search interface for determining the user customized stock setting information is provided through the user terminal 200, and the user determines and inputs the user customized stock setting information.

For example, the stock search interface is provided to the form of a popup window, and through the stock search interface, the information on an stock that is desired by the user to be added to the asset allocation model or the information on the stock held by the user in the user account of the financial server 300 is inputted.

Accordingly, the asset allocation engine management unit 120 updates and creates the user customized asset allocation model portfolio onto which the stock information of the user customized information is reflected and recalculated and provides the updated model portfolio through the optimal investment ratio interface 211.

That is, the asset allocation engine service providing device 100 creates the user customized asset allocation model through the asset allocation engine management unit 120, provides the real-time simulation through the simulation processing unit 150 (at step S113), and provides the result information to the user terminal 200.

For example, the asset allocation engine service providing device 100 provides, through a simulation interface 212 of the user terminal 200 as shown in FIG. 12, the past performance simulation for the initial portfolio model or simulation information of the simulation processing unit 150 according to the simulation of the current determined model portfolio, and for example, the simulation information includes expected annual average return, annual volatility, maximum drawdown, Sharpe ratios, and so on. Further, the simulation information outputs difference information compared to the previous model, and the user compares the current model created according to the user customized asset addition input to the previous model to thus determine whether the previous model is changed.

Further, the simulation processing unit 150 according to the present invention receives the conditional setting information based on the current asset, executes individual simulations, and outputs the simulation result. For example, the simulation processing unit 150 executes the individual simulations according to assets desired to be maintained by stock, minimal values, or ratio input.

Furthermore, the simulation processing unit 150 applies tuning information corresponding to the standard model, smart beta ETF configuration information, and category setting information, according to the user customized model created in the asset allocation engine management unit 120, executes transformed simulation, and outputs the classified results.

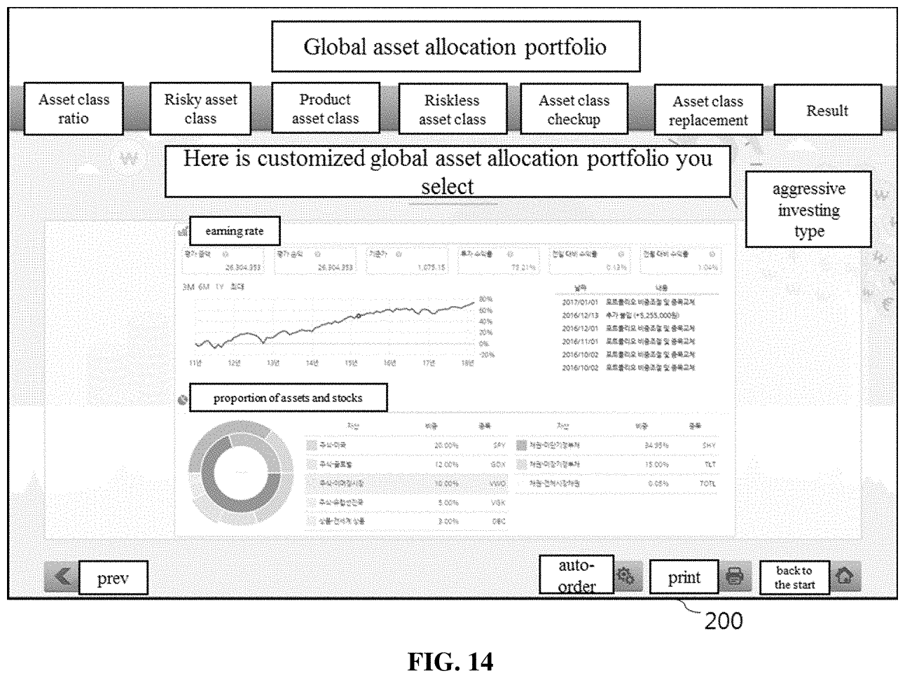

FIG. 14 shows a finally determined user customized asset allocation model portfolio interface outputted through the user terminal 200, and trading registration can be executed according to automatic order button input on the interface.

Accordingly, the asset allocation engine service providing device 100 provides the automated trading service based on the customized asset allocation model according to the trading registration through the trading processing unit 170 (at step S115) and provides the current asset allocation portfolio monitoring service according to the automated trading service (at step S117).

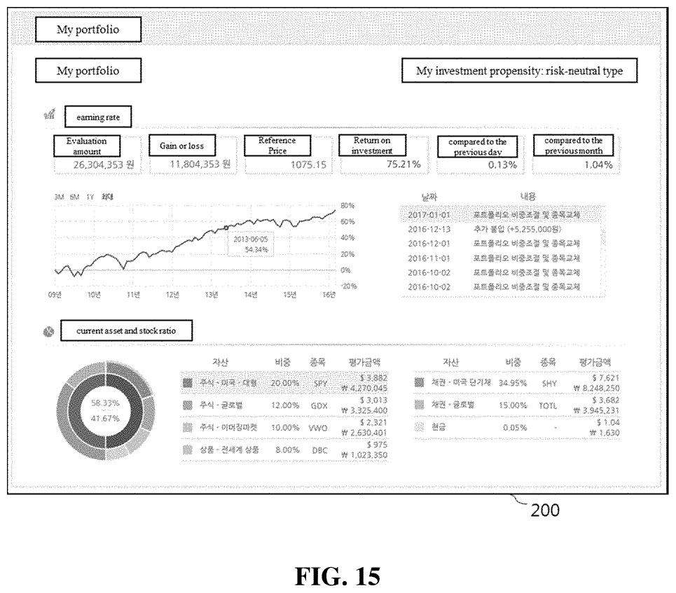

FIG. 15 shows a current asset allocation portfolio monitoring interface of the user, and if the user customized asset allocation model is determined finally, the trading processing unit 170 executes the automated trading process by stock which corresponds to the user customized asset allocation model set in advance, so that the process information is outputted through the current asset allocation portfolio monitoring interface.

On the other hand, the asset allocation engine service providing device 100 according to the present invention provides real-time model portfolio changing and real-time simulation processes during the monitoring, which will be explained now with reference to FIG. 6.

Referring back to FIG. 6, the asset allocation engine service providing device 100 outputs the current asset allocation model through the portfolio model of the user terminal 200 (at step S201).

The current asset allocation model is outputted to the monitoring form as shown in FIG. 15. However, in this case, the user changing setting information is received through the monitoring interface. For example, the user may add customized assets or input changed setting information for removing given stocks.

Further, the asset allocation engine service providing device 100 creates the changed portfolio according to the user changing setting information (at step S203).

The asset allocation engine management unit 120 changes and updates the current portfolio model from the user changing setting information and creates the changed portfolio model. The created portfolio model information is provided again through the portfolio interface as shown in FIG. 12.

If the changed portfolio is created, accordingly, the simulation processing unit 150 provides the real-time simulation result comparison between the previous portfolio model and the changed portfolio (at step S205).

Accordingly, the user checks the real-time simulation result comparison between the previous portfolio model and the changed portfolio to easily determine whether the portfolio model is changed.

According to the user changing request input to the user terminal 200, further, the asset allocation engine service providing device 100 executes reapplication of the changed portfolio to the current account and asset (at step S207), and the trading processing unit 170 executes the automated trading processing according to the reapplied portfolio (at step S209).

In this case, the asset allocation engine service providing device 100 executes the reapplication of the changed portfolio to the current account and asset, without separate addition of account information, thereby removing inconveniences and time consumption caused by new account opening and new model connection.

In the existing asset allocation service, that is, a new account has to be open or account information has to be added so as to change a model or reapply a changed model, thereby causing many conveniences, but according to the present invention, the asset allocation engine service providing device 100 executes the creation of the changed portfolio, the model simulation, and the reapplication, in real time, thereby supporting the customized model creation and changing according to the user's intervention to completely remove the existing inconveniences.

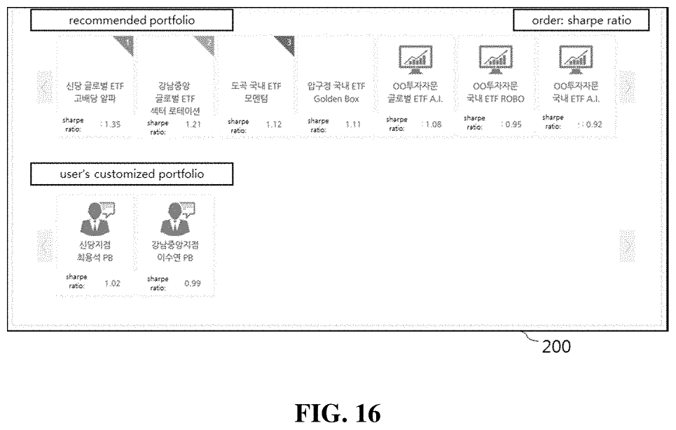

On the other hand, FIG. 16 shows a portfolio model sharing interface of the asset allocation engine service providing device 100 according to the present invention.

As shown in FIG. 16, the asset allocation engine service providing device 100 manages the customized asset portfolios according to the user customized setting through the web site management unit 160 and shares the customized asset allocation portfolios by user with the users through the web site. Further, the Sharpe ratio information corresponding to the respective customized asset allocation portfolios is provided to allow the users to determine the values of the portfolios.

The customized asset allocation portfolios by user shared with the users are provided to the second user terminal, and to do this, the asset allocation engine service providing device 100 matches the respective pieces of user information with the customized asset allocation portfolios and manages the results through the database management unit 180.

For example, the asset allocation engine service providing device 100 shares one or more recommended user customized asset allocation model information stored in the database management unit 180 to the second user terminal according to the user analysis information of the second user terminal.

Further, as shown in FIG. 16, the asset allocation portfolios by user are provided as one product and are thus traded on online market, thereby making it possible that the customized asset allocation portfolios are designed more efficiently by a specialist like designer or advisor as well as the investor and thus inducing market to become active.

Also, the customized asset allocation portfolio models by user are shared or traded in the market through the asset management service providing device 500, and to do this, the asset allocation engine service providing device 100 matches the respective pieces of user information with the customized asset allocation portfolios and manages the results through the database management unit 180. Further, the asset allocation engine service providing device 100 constitutes the created model information with the portfolio item information and transmits the portfolio item information to the sharing market module 530 of the asset management service providing device 500.

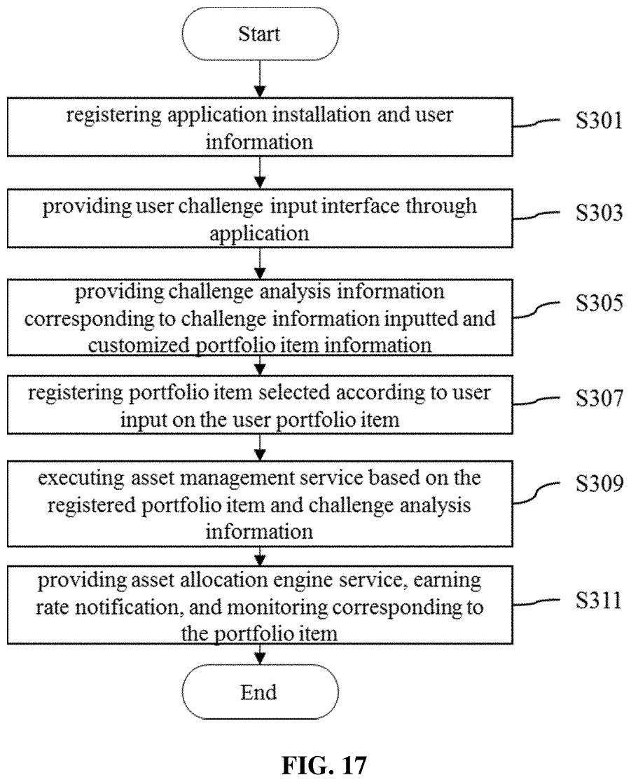

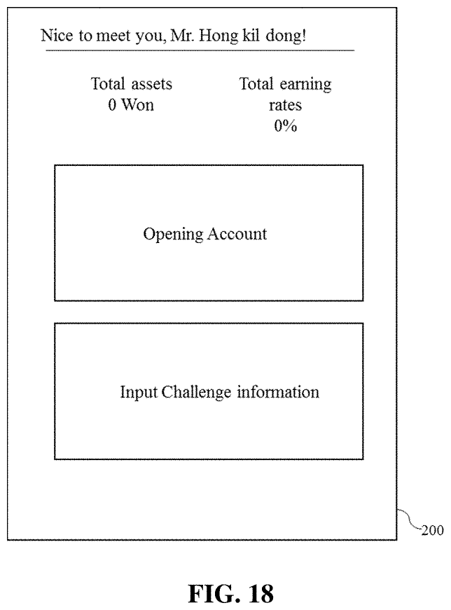

FIG. 17 is a flowchart showing an asset management service providing method according to the present invention, and FIGS. 18 to 24 show asset management service interfaces outputted from the user terminal through the asset management service providing method according to the present invention.

Referring to the flowchart of FIG. 17 and the interfaces of FIGS. 18 to 24, first, the asset management service providing device 500 according to the present invention provides application installation of the user terminal 200 through the application and web interface management unit 580 and executes the user information registration through the customized investment product management module 520 (at step S301).

As shown in FIG. 18, through the driving of the application according to the present invention, a user information registration interface inclusive of new account information and new challenge information input menus is outputted from the user terminal 200.

Further, the asset management service providing device 500 provides a user challenge input interface through the application provided to the user terminal 200 (at step S303), and the customized investment product management module 520 acquires challenge analysis information corresponding to the challenge information received from the user terminal 200, acquires customized port item information corresponding to the acquired challenge analysis information from the portfolio item-based sharing market module 530, and provides the customized port item information to the user terminal 200 (at step S305).

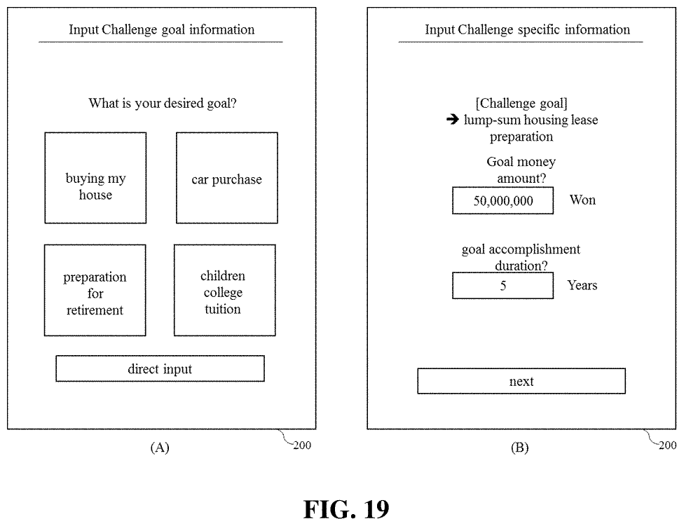

More specifically, as shown in FIG. 19A, the challenge information includes challenge goal information, and the user selects goal information set in advance, like my house buying, car purchase, preparation for retirement, and children college tuition or directly inputs other challenge goal information. Further, as shown in FIG. 19B, the challenge information includes specific information, and the specific information includes goal money amount information and goal accomplishment duration information.

Like this, the challenge information includes question and answer information for analyzing the user investment propensity and goal, and if the challenge analysis information based on the question and answer information is acquired, the customized investment product management module 520 indexes the port item (portfolio item) matched with the challenge analysis information from the portfolio item-based sharing market module 530 and provides the indexed result to the user terminal 200.

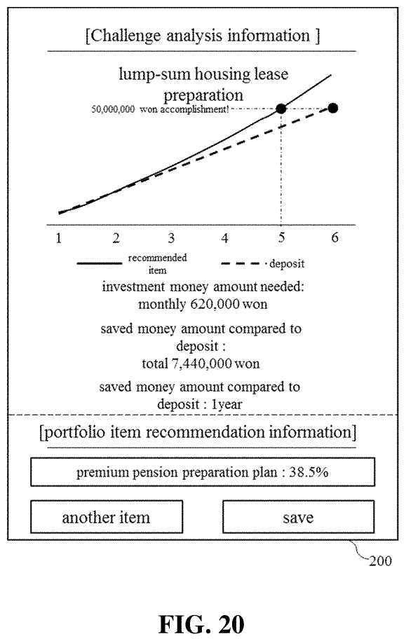

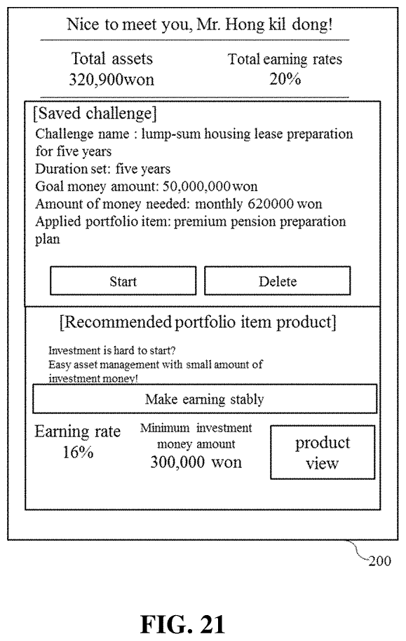

More specifically, as shown in FIGS. 20 and 21, the challenge information through the user information registration is outputted from the user terminal 200, and the asset management service providing device 500 provides recommended port item product information corresponding to the challenge analysis information to the user terminal 200.

FIG. 20 shows that the challenge analysis information corresponding to the challenge information is provided to the user terminal 200. Referring to FIG. 20, the challenge analysis information corresponding to lump-sum housing lease preparation for five years registered as the challenge information includes investment money amount information needed for goal accomplishment and investment duration information according to deposits, and comparison information with port item recommendation information is outputted to the interface of the user terminal 200. For example, as shown in FIG. 20, the earning rate of 38.5% of the port item ‘premium pension preparation plan’ and saved money amount and duration information compared to the deposits through the application of the recommended port item are outputted together.

FIG. 21 shows that as the recommended portfolio item product corresponding to the lump-sum housing lease preparation for five years, which is registered as the challenge information, recommended portfolio item product information entitled ‘make earnings stably, without any risk’ is outputted on the bottom end thereof. As shown in FIG. 21, the recommended portfolio item product information includes at least one of product explanation information, earning rate information, and minimum investment money amount information.

Further, the asset management service providing device 500 registers the port item selected in the user terminal 200 as the user port item through the customized investment product management module 520 (at step S307) and executes the asset management service based on the registered port item and the challenge analysis information (at step S309).

As the asset management service is executed, the asset management service providing device 500 provides the asset allocation engine service corresponding to the port item through the customized investment product management module 520 and the asset allocation engine service interworking unit 590 and provides the earning rate notification and monitoring service (at step S311).

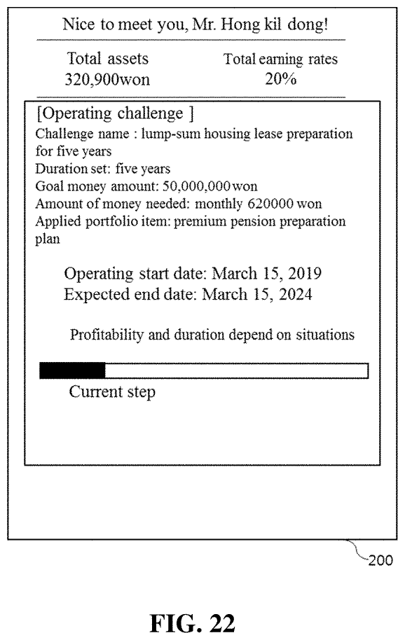

More specifically, FIG. 22 shows the interface screen of the user terminal 200 if the user selects the port item ‘premium pension preparation plan’. As shown in FIG. 22, the asset management service providing device 500 provides the asset allocation engine service based on the portfolio item through the asset management service, and operating start date information, expected finishing date information, current earning rate information, and current step ratio information, which correspond to the portfolio item selected according to the challenge, are outputted to the user terminal 200.

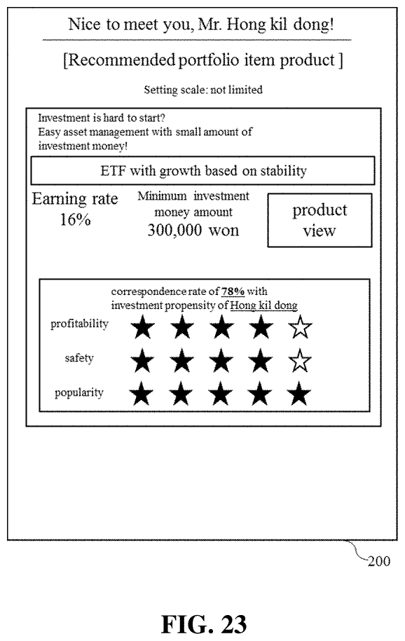

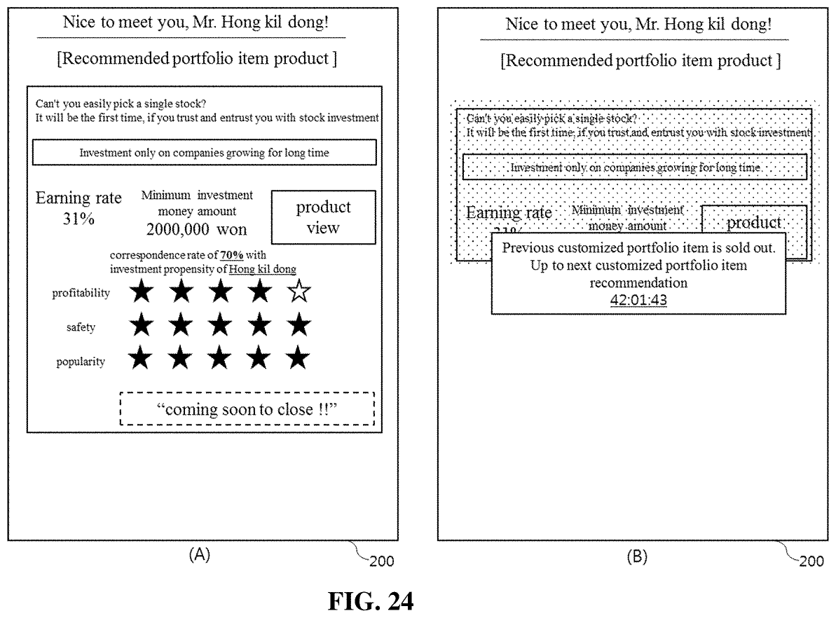

On the other hand, more specifically, FIGS. 23 to 24B show the recommended port item product information indexed by the product recommendation module of the customized investment product management module 520, and the asset management service providing device 500 indexes the portfolio item information corresponding to investment propensity by a given rate from the sharing market, according to the user analysis information through the user challenge analysis, and provides the indexed port item product information to the user terminal 200. As shown in FIG. 23, the investment propensity information is classified into reference information of profitability, safety, and popularity, and correspondence rate information on the classified reference information is outputted through the interface of the user terminal 200.

Referring further to FIGS. 24A and 24B, a maximum asset operating scale is additionally set as the setting information of the portfolio item according to the present invention.

Accordingly, the customized investment product management module 520 of the asset management service providing device 500 provides to the user terminal 200 a message ‘coming soon to a close’ as shown in FIG. 24A for the port item close within a given amount of money to the maximum asset scale among the port items recommended to the user. If the port item is sold out, the customized investment product management module 520 provides a message indicating that the previous customized port item is sold out to the user terminal 200. The customized port item recommendation is provided at given periods of time, and as shown in FIG. 24B, the time information remaining up to the next recommendation is outputted to the interface of the user terminal 200.

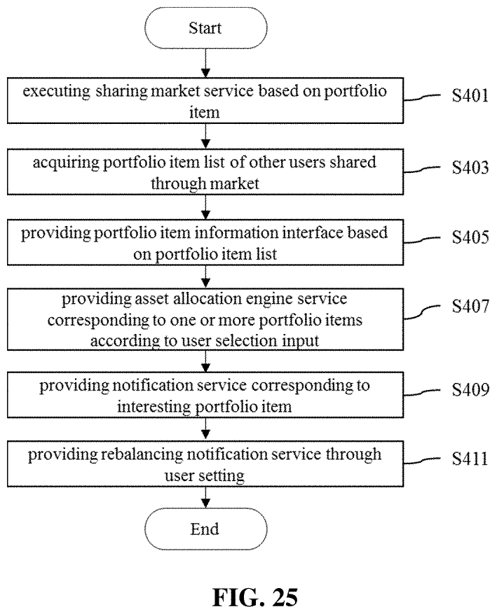

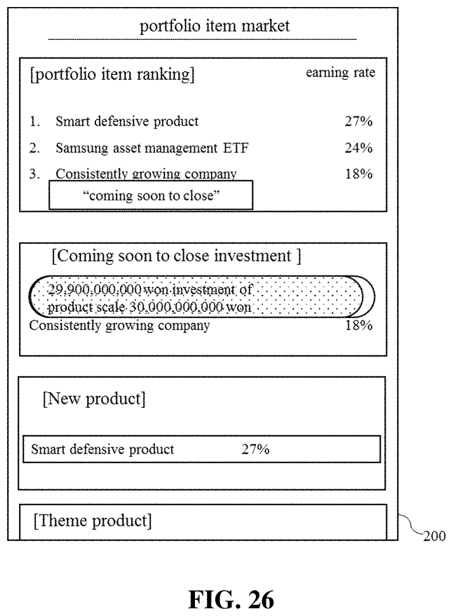

FIG. 25 is a flowchart showing a sharing market service operation of the asset management service providing device according to the present invention, and FIGS. 26 to 32 show asset management service interfaces provided to the user terminal through the sharing market service according to the present invention.

First, the sharing market service based on the port item is executed according to the installation and driving of the application in the user terminal 200 (at step S401).

In response to the request of the sharing market service in the user terminal 200, through the portfolio item-based sharing market module 530, the asset management service providing device 500 acquires the port item list of other users shared through the market (at step S403) and provides a port item information interface based on the port item list to the user terminal 200 (at step S405).

Referring to FIG. 26, the port item list is processed and outputted to various forms to the user terminal 200, and for example, the port item list includes earning rate-based port item ranking, coming soon to a close port item, new port item, and theme classification.

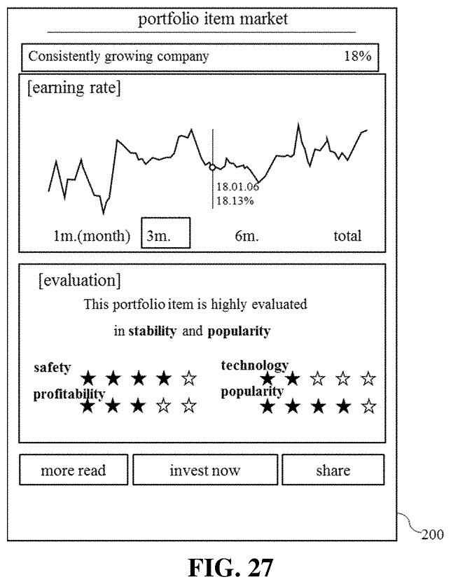

Further, as shown in FIG. 27, if the user selects a given port item, basic information on the selected port item is outputted through the port item information interface. Referring to FIG. 27, the port item information interface includes a port item name, information on earning rate by duration, and evaluation information, and the user terminal 200 is provided with a now investment menu together with a specific information view menu or read more menu, thereby allowing the user to immediately input the selection and application of the port item.

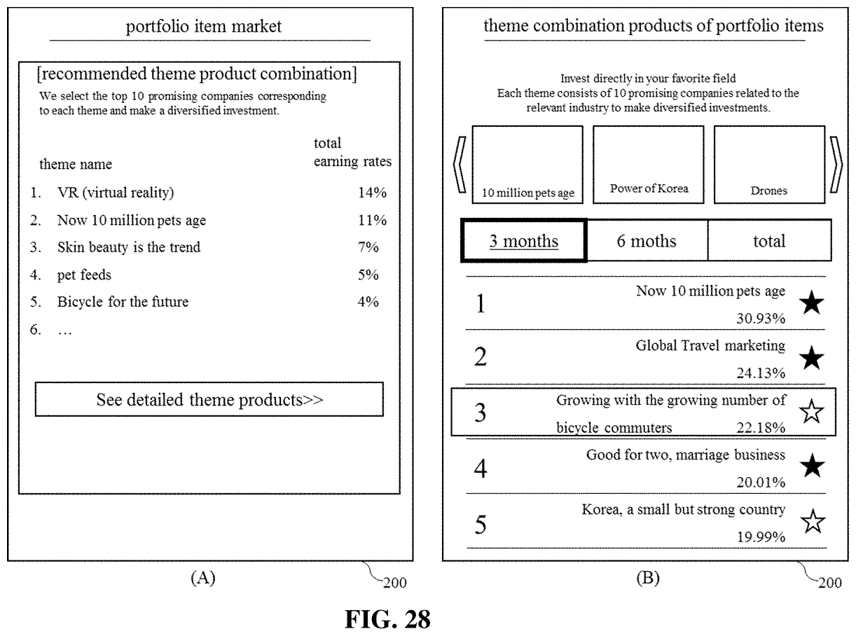

On the other hand, as shown in FIGS. 28A and 28B, the port item list is sortedly provided according to theme classification information set in advance, and through the user terminal 200, the port item list by theme is outputted. As shown in FIGS. 28A and 28B, the port items are combined according to themes set in advance, and the total earning rate through the combination is calculated. Accordingly, theme port items are combined port items created from the portfolio item theme management unit 550 according to the theme keyword information matching determined in advance, and the port items by theme are created. Also, the total earning rates of the port items are calculated individually and managed.

FIG. 28A shows total earning rate ranking in the port items according to combination in a given number of high level of theme products, and FIG. 28B shows a list of the theme product combined port items according to the user selection.

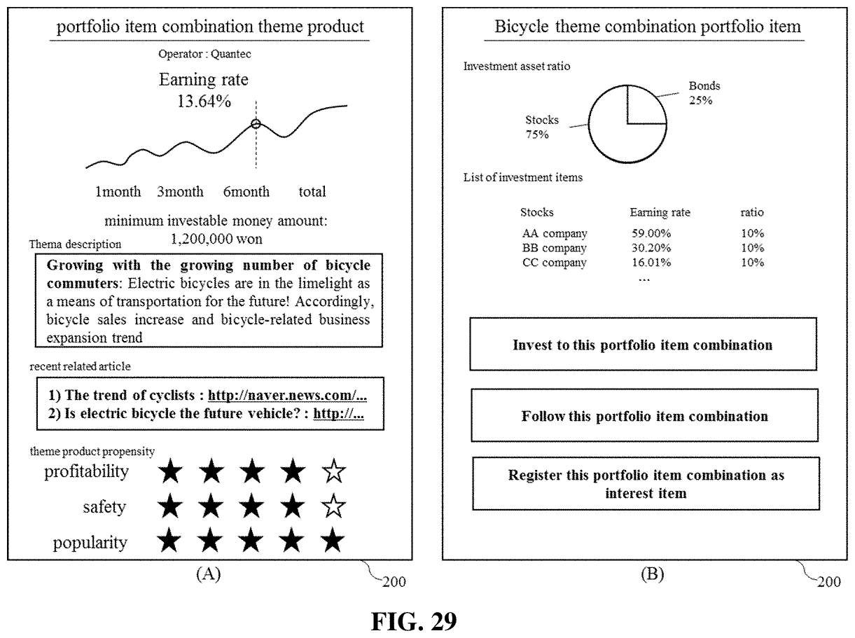

As shown in FIGS. 29A and 29B, if the user selects a specific theme, specific information on the selected theme is outputted. In FIG. 29A, operating subject information, earning rate information, minimum investable money amount information, theme explanation information, related articles information, product propensity information, which correspond to the theme port items, are provided to the user terminal 200, and in FIG. 29B, investment asset rate information and investment stock list information are provided to the user terminal 200. Accordingly, the user terminal 200 receives the user input such as the theme combined type port item investment and follow or interesting port item registration and requests the asset management service providing device 500 to execute the processing for the received user input.

On the other hand, the asset management service providing device 500 provides the asset allocation engine service corresponding to one or more port items according to the user application and selection input (at step S407).

If the interesting port item is set, the asset management service providing device 500 provides the notification service corresponding to the interesting port item through the notification management unit 570 (at step S409) and further provides a rebalancing notification service corresponding to the current applied port item through user setting (at step S411).

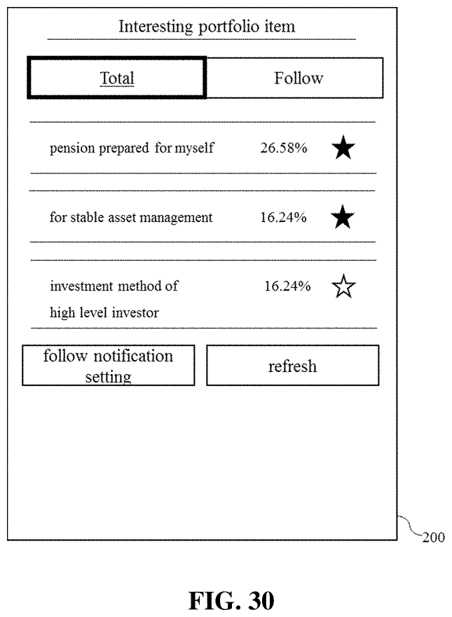

More specifically, as shown in FIG. 30, if the interesting port item is set by the user, the user terminal 200 provides follow setting and notification setting functions through the interesting port item interface.

The asset management service providing device 500 creates the notification message according to the port item monitoring and provides the created message to the user terminal 200 through the notification management unit 570, and the notification setting information includes rebalancing notification corresponding to the applied port item or the follow notification setting corresponding to the interesting port item.

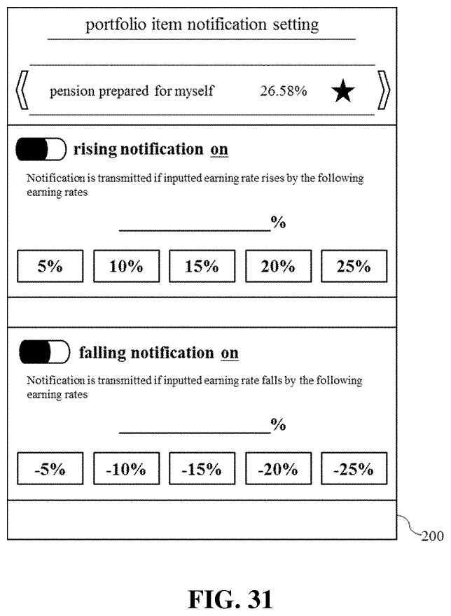

Especially, as shown in FIG. 31, the notification setting information includes at least one of rising notification setting information in which the notification message is transmitted if the earning rates of the interesting portfolio items rise over earning rates set in advance and falling notification setting information in which the notification message is transmitted if the earning rates of the interesting portfolio items fall under the earning rates set in advance.

FIG. 31 shows both of the rising notification setting and the falling notification setting, and as the user sets a specific rising notification earning rate and a specific falling notification earning rate, he or she can check a situation in the earning rate of the interesting port item even though he or she does not monitor the situation every time.

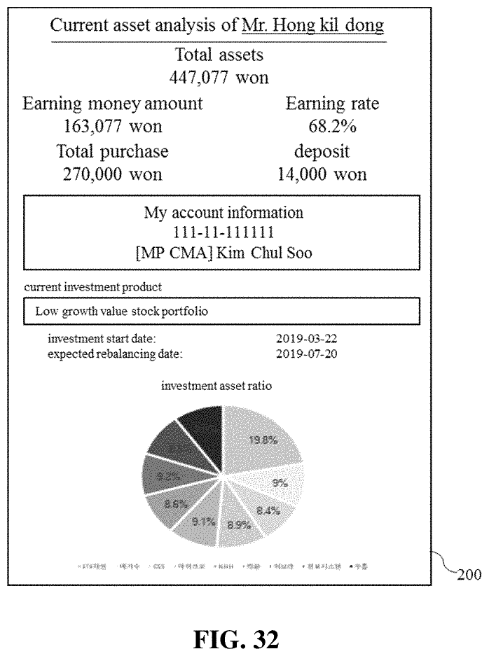

On the other hand, FIG. 32 shows a current asset analysis interface according to the asset allocation engine service. Referring to FIG. 32, the asset management service providing device 500 requests the asset allocation engine service providing device 100 to provide the asset allocation engine service according to the application of the port item and provides a user interface for the asset allocation service to the user terminal 200. The asset allocation service provided is monitored through the current asset analysis interface of the user terminal 200, and according to the user input or request as will be made later, the automated trading process is executed through the simulation and monitoring as shown in FIG. 12 or 14. The result information is provided to the user terminal 200.

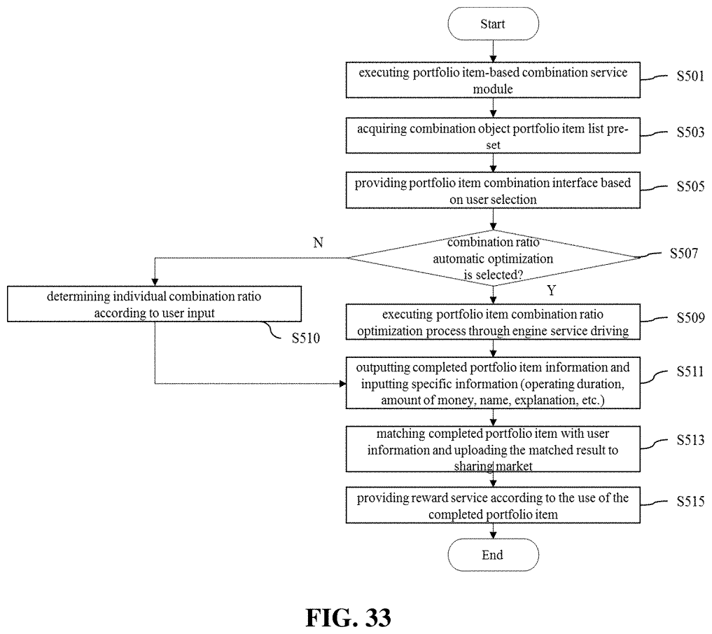

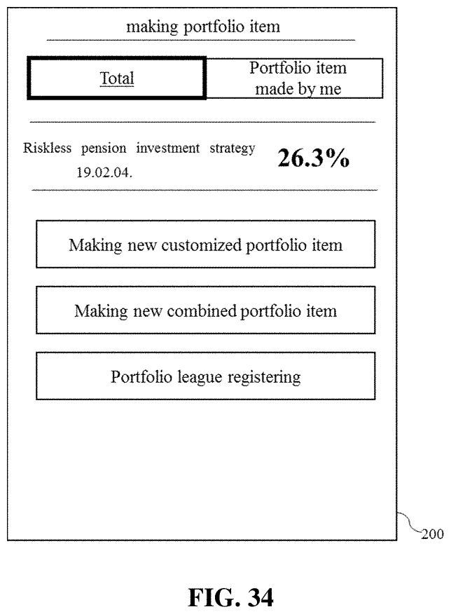

FIG. 33 is a flowchart showing a portfolio item creating process of the asset management service providing device according to the present invention, and FIGS. 34 to 40 show the asset management service interfaces outputted from the user terminal through the portfolio item creating process according to the present invention.

Referring to FIG. 33, if a port item-based combination service module is executed in the user terminal 200 (at step S501), the asset management service providing device 500 acquires the combination object port item list set in advance through the portfolio item combination creating unit 540 and provides the acquired list to the user terminal (at step S503).

Next, the port item combination interface based on the user selection is provided through the user terminal 200 (at step S505).

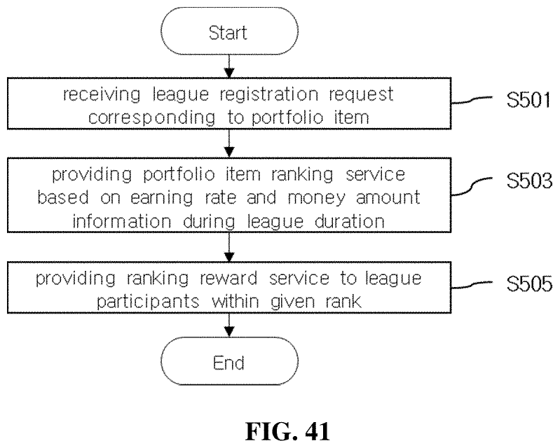

FIG. 34 shows the port item creating interface, and the port item is created according to the user analysis and customized setting information through the asset allocation engine service providing device 100. Otherwise, the port item may be created in combined type. In the embodiment of the present invention, a combined type port item creating process, which is easy to be created according to the user selection, will be explained. Further, as shown in FIG. 34, it is possible to request the league registration corresponding to the created item, which will be discussed later with reference to FIG. 41.

The user selects one or more port items to be combined from the port items shared in advance through the market, through the port item combination interface.

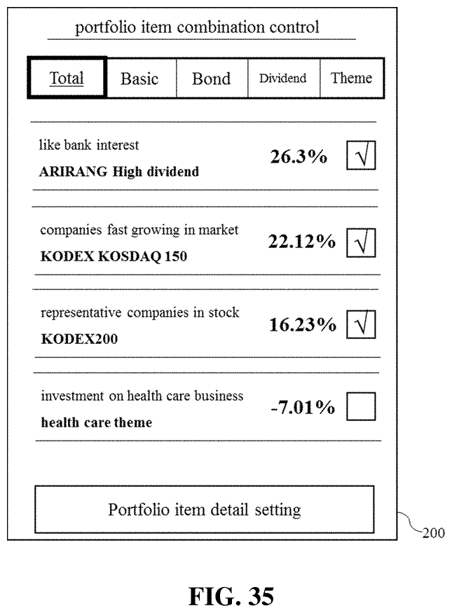

Referring to FIG. 35, the user checks the earning rates of one or more port items and sets combination information. For example, the port items include basic, bond, dividend, and theme port items, and the user combines and selects a specific number of port items to make a new port item. Further, the user terminal 200 selects the combined type port items created by other users as the combination objects, and accordingly, it is possible that another combined type port item is created with the combined port items.

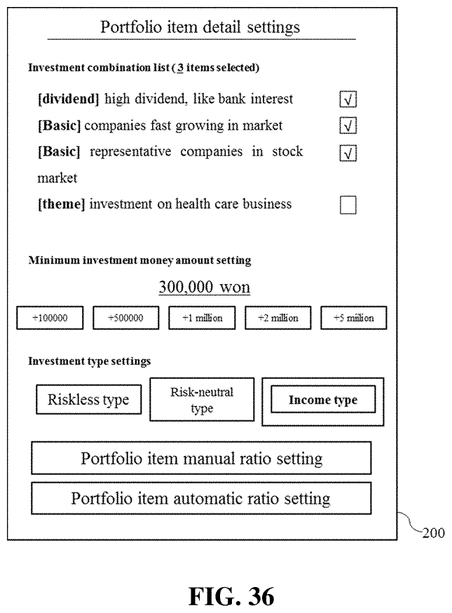

Referring to FIG. 36, further, the port items to be combined are set specifically, and for example, the specific setting includes minimum investment money amount information, maximum operating scale information, investment type information, and port item ratio setting information.

In this case, the user terminal 200 determines whether combination ratio automatic optimization for the port items combined is selected (at step S507).

Referring to FIG. 36, if a port item automatic ratio menu is inputted, the automatic optimization is selected, and accordingly, the user terminal 200 transmits an optimization request to the asset management service providing device 500. In this case, the asset management service providing device 500 executes a port item combination ratio optimization process through the engine service simulation driving of the asset allocation engine service interworking unit 590 (at step S509).

In FIG. 36, on the other hand, if a port item manual ratio menu is inputted, the automatic optimization is not selected, and accordingly, the user terminal 200 determines individual combination ratios according to the user input (at step S510).

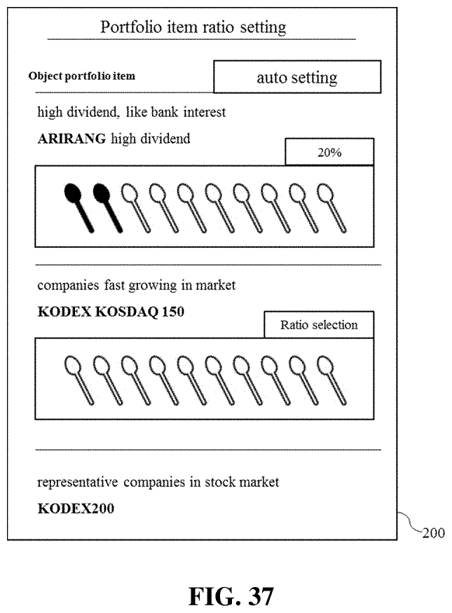

FIG. 37 shows a manual ratio setting interface for determining the individual combination ratios, and the user terminal 200 outputs the manual ratio setting interface through which the combination ratios by port item are inputted individually. For example, as shown in FIG. 37, the port items to be combined are handled like one food, and the ratios of materials (port items) are indicated and inputted with the number of spoons. Accordingly, it is possible that product creating and sharing are easy without any separate hard investment explanations or concepts.

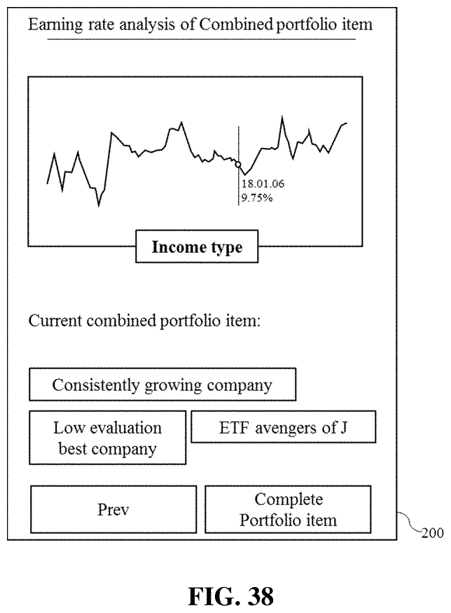

On the other hand, as shown in FIG. 38, if there is a request of the user terminal 200 through the individual combination ratio input, the asset management service providing device 500 provides the engine service simulation driving results as individual responses through the asset allocation engine service interworking unit 590, thereby helping the user expect the portfolio earning rates.

If the combination ratios are determined, the user terminal 200 outputs completed port item information and receives specific information (operating duration, amount of money, name, explanation, etc.) (at step S511), and the asset management service providing device 500 matches the completed port item with the user information and uploads the matched result to the sharing market (at step S513).

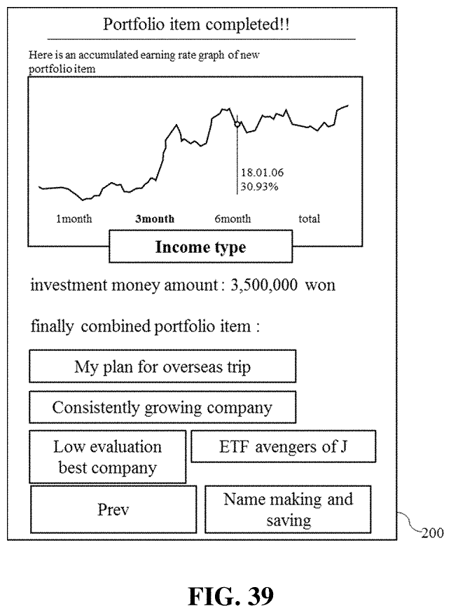

FIG. 39 shows a port item completing screen, and as shown in FIG. 39, the combination object port item information constituting the port item, the investment money amount information, and accumulated earning rate information currently calculated are outputted through the user terminal 200.

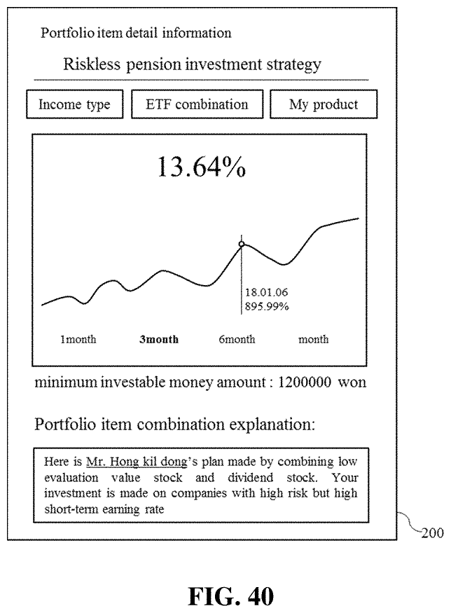

FIG. 40 shows specific information on the port item shared in the market through the portfolio item-based sharing market module 530, and other users can check the characteristics and creator information on the current combined type port item through the port item combination explanation in the specific information. Further, other users can check purpose, earning rate, and investable money amount information.

After that, the asset management service providing device 500 provides the reward service for the use of other users of the completed port item through the portfolio item-based sharing market module 530 (at step S515). In this case, the reward service includes earning distribution and usage fee payment.

FIG. 41 is a flowchart showing a portfolio item-based league process according to the present invention.

Referring to FIG. 41, the asset management service providing device 500 receives the league registration request corresponding to the port item through the league operating unit 560 (at step S401).

In this case, the port items for which the league registration is possible are desirably limited to the new port items created by the individual users.

Further, the league operating unit 560 provides a port item ranking service based on the earning rate and money amount information during the league duration (at step S403) and provides a ranking reward service to the league participants within a given rank (at step S405).

Through the league service operation, the asset management service providing device 500 enhances a user participation rate, and accordingly, the various portfolio items according to the present invention can be shared and served through the market.

The method according to the present invention as described above may be made in the form of a program that can be performed through computers, and the method may be recorded in a computer readable recording medium. The computer readable recording medium may include a ROM, a RAM, a magnetic tape, a floppy disc, and an optical data recording medium.

The computer readable recording medium is distributed to computer systems connected to networks, and in the computer systems, computer readable codes are recorded and executed in the form of distribution. Further, functional programs, codes, and code segments for performing the method can be easily inferred by the programmers in the art.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings. It is therefore intended that the scope of the invention be limited not by this detailed description, but rather by the claims appended hereto.

1. An asset allocation service providing method of a service providing device, comprising the steps of:
acquiring user analysis information from user input information inputted to a user terminal;
determining asset setting information corresponding to the user analysis information;
applying the asset setting information to an asset allocation engine based on model information pre-stored to create initial portfolio information;
providing the initial portfolio information to the user terminal and acquiring user customized information corresponding to the initial portfolio information from the user terminal; and
providing real-time simulation information using a user customized asset allocation model determined based on the user customized information to the user terminal.

2. The asset allocation service providing method according to claim 1, further comprising the steps of:
executing an automated trading process based on the user customized asset allocation model according to user trading registration information inclusive of user account information and initial asset information; and
providing current asset allocation portfolio monitoring information according to the automated trading process.

3. The asset allocation service providing method according to claim 2, wherein the step of providing the monitoring information further comprises the steps of:
providing the current asset allocation portfolio model information through a portfolio interface of the user terminal;
receiving changed setting information corresponding to the current asset allocation portfolio model information from the user terminal;
creating a changed portfolio model based on the changed setting information; and
executing a simulation based on the changed portfolio model to provide real-time simulation result comparison information between the current asset allocation portfolio model and the changed portfolio model to the user terminal.

4. The asset allocation service providing method according to claim 2, further comprising the steps of:
receiving a real-time portfolio model changing request from the user terminal; and
executing reapplication of the changed portfolio model corresponding to current account and asset of the user trading registration information according to the real-time portfolio model changing request.

5. The asset allocation service providing method according to claim 4, wherein the step of executing the reapplication comprises the steps of:
acquiring current account information and current asset information corresponding to the user trading registration information pre-registered, without added or changed registration in the user trading registration information;
executing an automatic changing process of the user trading registration information so as to reapply the current account information and the current asset information to the changed portfolio model from the current portfolio model; and
executing an automated trading process according to the automatically changed user trading registration information and the changed portfolio model.

6. A terminal operating method for providing an asset management service, comprising the steps of:
receiving user input information for acquiring user analysis information and transmitting the user input information to an asset management service providing device;
receiving one or more investment asset-related portfolio items selected according to the user analysis information from a portfolio item market built based on an online network from the asset management service providing device to output the received portfolio items through a portfolio item interface; and
requesting the asset management service providing device to provide an asset allocation engine service corresponding to the selected portfolio items according to the user input corresponding to the portfolio item interface.

7. The terminal operating method according to claim 6, wherein the portfolio items comprise an investment product data set of a customized portfolio model created according to the user analysis information of a portfolio item creator who shares the portfolio items in the portfolio item market.

8. The terminal operating method according to claim 7, wherein the portfolio items comprise combined portfolio items created by the combination of a plurality of portfolio items registered on the portfolio item market, and the combined portfolio items comprise pieces of portfolio item identification information and ratio setting information corresponding to the pieces of portfolio item identification information.

9. The terminal operating method according to claim 6, wherein the asset allocation engine service comprises an automated trading service of a product asset based on the portfolio items, and if earning occurs on the product asset invested according to the automated trading, the asset management service providing device provides a reward service to the portfolio item creator according to portfolio item setting information.

10. The terminal operating method according to claim 6, further comprising the steps of:
registering one or more portfolio items as interesting portfolio items according to user input; and
providing a notification service corresponding to the interesting portfolio items,
wherein the step of providing the notification service comprises the steps of:
registering notification setting information based on earning rates corresponding to the interesting portfolio items on the asset management service providing device; and
providing a notification message received from the asset management service providing device according to the notification setting information,
the notification setting information comprising at least one of rising notification setting information in which the notification message is transmitted if the earning rates of the interesting portfolio items rise over earning rates pre-set and falling notification setting information in which the notification message is transmitted if the earning rates of the interesting portfolio items fall under the earning rates pre-set.

11. The terminal operating method according to claim 6, further comprising the step of providing a portfolio item combination interface for combining and creating personalized portfolio items through the portfolio items registered in the portfolio item market to the user terminal, the portfolio item combination interface comprising a portfolio item combination control interface selectable according to user input from the plurality of portfolio items registered in the portfolio item market.

12. An asset management service providing method of a service providing device, comprising the steps of:
acquiring user analysis information according to user input information inputted to a user terminal;
providing a portfolio item interface inclusive of one or more investment asset-related portfolio items selected according to the user analysis information from a portfolio item market built based on an online network; and
providing an asset allocation engine service with real-time simulation information corresponding to the selected portfolio items according to the user input corresponding to the portfolio item interface.

13. The asset management service providing method according to claim 12, wherein the portfolio items comprise an investment product data set of a customized portfolio model created according to the user analysis information of a portfolio item creator who shares the portfolio items in the portfolio item market.

14. The asset management service providing method according to claim 12, wherein the asset allocation engine service comprises an automated trading service of a product asset based on the portfolio items, and if earning occurs on the product asset invested according to the automated trading, a reward service is provided to the portfolio item creator according to portfolio item setting information.

15. The asset management service providing method according to claim 12, further comprising the step of providing a portfolio item combination interface for combining and creating personalized portfolio items in the portfolio items registered in the portfolio item market to the user terminal, the portfolio item combination interface comprising a portfolio item combination control interface selectable according to user input from the plurality of portfolio items registered in the portfolio item market.

16. The asset management service providing method according to claim 12, wherein the portfolio items comprise user customized asset allocation model information created by the portfolio item creator, and the asset allocation engine service comprises an automated trading and monitoring service using the user customized asset allocation model corresponding to the portfolio items, the automated trading and monitoring service comprising the steps of providing current asset allocation portfolio model information through a portfolio interface of the user terminal, receiving changed setting information corresponding to the current asset allocation portfolio model information from the user terminal, creating a changed portfolio model based on the changed setting information, executing a simulation based on the changed portfolio model, providing real-time simulation result comparison information between the current asset allocation portfolio model and the changed portfolio model to the user terminal, and if a real-time portfolio model changing request is received from the user terminal, executing reapplication of the changed portfolio model corresponding to current account and asset of the user trading registration information according to the real-time portfolio model changing request.
